(19) United States
(12) Patent Application Publication
(10) Pub. No.: US 2026/0169234 A1
(43) Pub. Date: Jun. 18, 2026

(54) Fiber Optic Connector with Mechanical Advantage

(71) Applicant: US Conec Ltd., Hickory, NC (US)

(72) Inventors: Jillcha F. Wakjira, Hickory, NC (US); Jason Higley, Hickory, NC (US); Scott Mendenhall, Hickory, NC (US); Darrell R. Childers, Hickory, NC (US)

(21) Appl. No.: 18/742,836

(22) PCT Filed: Dec. 21, 2022
(86) PCT No.: PCT/US2022/053717

§ 371 Date: Jun. 13, 2024

Related U.S. Application Data
(60) Provisional application No. 63/292,828, filed on Dec. 22, 2021.

(51) Int. Cl. G02B 6/38

(52) U.S. Cl. CPC G02B 6/3871; G02B 6/3825

(57) ABSTRACT

A fiber optic connector includes a fiber optic ferrule supporting at least one optical fiber terminated at a front end of the fiber optic ferrule, a housing partially surrounding the fiber optic ferrule, a carrier engaged to the housing rearward thereof, a connector boot coupled to the carrier at a rear portion of the carrier, and a converter coupled to the connector boot at a front portion of the connector boot and having an engagement mechanism to engage with an adapter within which the fiber optic connector mates with another fiber optic connector. The connector boot is movable rotationally between a plurality of positions with a torque. A longitudinal force generated on the converter and on the carrier is transferred to the fiber optic ferrule as a mating force for mating with another fiber optic ferrule. There may be a turning element attached to the connector boot that is rotationally movable.

### REFERENCE TO RELATED CASE

This application claims priority under 35 U.S.C. § 119 (e) to U.S. provisional application no. 63/292,828 filed on Dec. 22, 2021, the contents of which are hereby incorporated by reference in their entirety.

### BACKGROUND OF THE INVENTION

For physical contact fiber optic connectors, typically a mating force is required to be maintained for establishing and maintaining proper alignment of an optical connection. This mating force typically increases as the number of fibers that are mated increases, and as a group of fiber optic ferrules ganged within a single fiber optic connector that are mated increases. For example, force requirements for a single fiber connector (e.g., LC) are lower than those for a single fiber optic ferrule multi-fiber connector (e.g., MPO). Further, force requirements for such single fiber optic ferrule multi-fiber connectors are lower than ganged uni-boot fiber optic connectors in which each member of the gang of connector housings has two single fiber ferrules (i.e., a gang of duplex fiber optic connectors). One such ganged fiber optic connector is disclosed in Applicant's International Patent Application Publication no. WO 2021/127531 (Atty. Dkt. USCO- 126-INT, hereinafter “the '531 publication”), filed Dec. 18, 2020, the contents of which are incorporated herein by reference.

Typically, an end user of such fiber optic connectors applies these forces to align, insert and finally mate a fiber optic connector to another fiber optic connector inside an adapter. The end user generally pushes the fiber optic connector in the mating direction by applying a linear/longitudinal force for mating. The end user may experience forces upward of 40N, and even as high as 60N—the spring force being 10N per connector. Typically, 30N is acceptable, and 20N or less is preferred. Further, the end user has to perform the aforementioned operations several times for many connectors (e.g., on an adapter panel of servers in a data center). This raises ergonomic challenges that make handling the fiber optic connectors inconvenient for end users when used repetitively.

Yet, another type of ganged connectors are used for attachment to a daughter card. Those connectors typically have about 3N per connector, and when used in a six (6) port connection, add to about 18N total to the user, which is under 20N. However, ganging of connectors for a daughter card application has different requirements than ganging for a backplane adapter on a rack unit of a server.

Accordingly, there is a need for reducing the forces needed for the user to insert ganged connectors in a backplane application, for example, for mating to the transceiver connector side of an optical link. That is, even though the actual mating forces may be up to 40N, there is a need in the industry that the user does not encounter such high forces.

### SUMMARY OF THE INVENTION

According to one aspect, the present invention is directed to a fiber optic connector that includes a fiber optic ferrule supporting at least one optical fiber terminated at a front end of the fiber optic ferrule, a housing partially surrounding the fiber optic ferrule, a carrier engaged to the housing rearward thereof, a connector boot coupled to the carrier at a rear portion of the carrier, and a converter coupled to the connector boot at a front portion of the connector boot and having an engagement mechanism to engage with an adapter within which the fiber optic connector mates with at least one another fiber optic ferrule on an opposite side of the adapter in a longitudinal direction, wherein the connector boot is movable rotationally between a plurality of positions with a torque about a longitudinal axis, the torque generating a longitudinal force on the converter and on the carrier, the longitudinal force being transferred to the fiber optic ferrule as a mating force for mating with the at least one another fiber optic ferrule.

In some embodiments, the carrier includes a crimp body.

In some embodiments, the carrier biases the engagement mechanism against a portion of the adapter after the longitudinal force has been applied.

In some embodiments, the connector boot has a projection and the converter has a groove to receive the projection on the connector boot.

In some embodiments, the projection extends around at least a portion of a circumference of the connector boot.

In some embodiments, the groove in the connector boot has a locking portion to prevent unintended movement of the carrier and converter.

In yet another aspect, there is a fiber optic connector that includes a fiber optic ferrule supporting at least one optical fiber terminated at a front end of the fiber optic ferrule, a housing partially surrounding the fiber optic ferrule, a turning element located rearward of the housing, and a converter coupled to the turning element at a front portion of the turning element and having an engagement mechanism to engage with an adapter, wherein the turning element is movable rotationally about a longitudinal axis between a plurality of positions to exert a longitudinal force to the fiber optic ferrule.

In some embodiments, the longitudinal axis about which the turning element is moved is orthogonal to a longitudinal axis to the fiber optic connector.

In some embodiments, there is also a carrier engaged at the front of the turning element.

In some embodiments, the turning element has a groove and the converter has a projection to engage the groove in the turning element.

In yet another aspect, there is a fiber optic connector that includes a fiber optic ferrule supporting at least one optical fiber terminated at a front end of the fiber optic ferrule, a housing partially surrounding the fiber optic ferrule, a turning element located rearward of the housing, and a converter coupled to the turning element at a front portion of the turning element and having an engagement mechanism to engage with an adapter, wherein the turning element is movable rotationally orthogonally to a longitudinal axis along the fiber optic connector between a plurality of positions to exert a longitudinal force to the fiber optic ferrule, whereby the fiber optic ferrule moves between a first longitudinal position to a second longitudinal position in response to the longitudinal force.

In some embodiments, the turning element is at least one lever engaged at a rear portion of the fiber optic connector.

In some embodiments, the turning element is a lever arm that is rotationally coupled to an engagement mechanism on the housing of the fiber optic connector.

In some embodiments, there is also a carrier attached to the housing and located rearward of the housing, wherein the engagement mechanism is in contact with the carrier to exert the longitudinal force.

In other embodiments, the engagement mechanism is latched at an adapter opening or window prior to the fiber optic ferrule mating.

It is to be understood that both the foregoing general description and the following detailed description of the present embodiments of the invention are intended to provide an overview or framework for understanding the nature and character of the invention as it is claimed. The accompanying drawings are included to provide a further understanding of the invention, and are incorporated into and constitute a part of this specification. The drawings illustrate various embodiments of the invention and, together with the description, serve to explain the principles and operations of the invention.

### BRIEF DESCRIPTION OF THE DRAWINGS

FIG. 1 is a schematic view of a first embodiment of a fiber optic connector in a first position according to the present invention;

FIG. 2 is a schematic view of the first embodiment in FIG. 1 in a second position;

FIG. 3 is a top left perspective view of the first embodiment of a fiber optic connector according to the present invention disposed within an adapter;

FIG. 4 is a top left perspective view of the fiber optic connector in FIG. 3 with a cross section of the converter;

FIG. 5 is a cross section view of the fiber optic connector in FIG. 3 disposed within the adapter;

FIG. 6 is a side view of one embodiment of a turning element used in the fiber optic connector in FIG. 3;

FIG. 7 is a perspective view of the turning element in FIG. 6;

FIG. 8 is a front elevational view of the turning element in FIG. 6;

FIG. 9A is a front elevational view of one embodiment of a converter used in the fiber optic connector in FIG. 3;

FIG. 9B is a rear elevational view of the converter in FIG. 9;

FIG. 10A is a top elevational view of the converter in FIG. 9;

FIG. 10B is top perspective view of the inside top of the converter in FIG. 9;

FIG. 11A is a front left perspective view of one embodiment of a carrier used in the fiber optic connector in FIG. 3;

FIG. 11B is a rear right perspective view of the carrier in FIG. 11A

FIG. 12 is an exploded view of the carrier in FIG. 11A;

FIG. 13 is a rear perspective view of the fiber optic connector in FIG. 3 with a partial cross-section of the converter attached thereto;

FIG. 14 is a rear perspective view of a partial cross section of the fiber optic connector in FIG. 3 before the turning element is turned;

FIG. 15 is a rear perspective view of a partial cross section of the fiber optic connector in FIG. 14 after the turning element is turned;

FIG. 16 is a top left perspective view of a partial cross section of a second embodiment of a fiber optic connector according to the present invention;

FIG. 17 is a top left perspective view of the second embodiment of a fiber optic connector in FIG. 16 with the converter removed therefrom;

FIG. 18 is a side perspective view of one embodiment of a turning element used in the fiber optic connector in FIG. 16;

FIG. 19 is a perspective view of the turning element in FIG. 18;

FIG. 20 is a front view of the turning element in FIG. 18;

FIG. 21 is a rear elevational view of one embodiment of a converter used in the fiber optic connector in FIG. 16;

FIG. 22 is a front elevational view of the converter in FIG. 21;

FIG. 23 is a front left perspective view of one embodiment of a carrier used in the fiber optic connector in FIG. 16;

FIG. 24 is an exploded view of the carrier in FIG. 23;

FIG. 25 is a cross section view of a third embodiment of a fiber optic connector according to the present invention;

FIG. 26 is a ganged crimp body that may be used with fiber optic connector in FIG. 25;

FIG. 27 is a perspective view of a converter to be used with the fiber optic connector in FIG. 25;

FIG. 28 is a perspective view of a cross section of the converter in FIG. 27;

FIG. 29 is a perspective view of a boot and turning element to be used with the fiber optic connector in FIG. 25;

FIG. 30 is a schematic view of a fourth embodiment of a fiber optic connector in a first position according to the present invention;

FIG. 31 is a schematic view of the fourth embodiment in FIG. 30 in a second mating position;

FIG. 32 is a top left perspective view of the first embodiment of a fiber optic connector according to the present invention disposed within an adapter;

FIG. 33 is a top, front left perspective view of the fiber optic connector in FIG. 32 with the slider removed;

FIG. 34 is a top left perspective view of the fiber optic connector in FIG. 32 with the slider removed;

FIG. 35 is a front view of fiber optic connector in FIG. 32;

FIG. 36 is a rear view of fiber optic connector in FIG. 32;

FIG. 37 is a top perspective view of a latch to engage the connector housing in the fiber optic connector in FIG. 32;

FIG. 38 is a bottom perspective view of the latch in FIG. 37;

FIG. 39 is a perspective view of one embodiment of a lever used with the fiber optic connector in FIG. 32;

FIG. 40 is a left perspective view of a partial cross section of the fiber optic connector in FIG. 32;

FIG. 41 is a top view of a portion of the fiber optic connector in FIG. 32;

FIG. 42 is a top perspective view of a partial cross section of the fiber optic connector in FIG. 32 showing the lever in FIG. 39;

FIG. 43 is a perspective view from the front of the slider used the fiber optic connector in FIG. 32;

FIG. 44 is a perspective view from the rear of the slider used the fiber optic connector in FIG. 32;

FIG. 45 is a top perspective view of a portion of the fiber optic connector in FIG. 32 showing the latch and slider;

FIG. 46 is a left side perspective view of a portion of the fiber optic connector in FIG. 32;

FIG. 47 is a left side perspective view of a relief that may be used with the fiber optic connector in FIG. 32;

FIG. 48 is a perspective view of a window in the slider that engages the wing in FIG. 42;

FIG. 49 is a front perspective view of one embodiment of a carrier that can be used with the fiber optic connector in FIG. 32;

FIG. 50 is a rear perspective view of the carrier in FIG. 49;

FIG. 51 is a perspective view of the bottom side of the carrier in FIG. 49 engaging the housings of the fiber optic connector in FIG. 32 and a partial cross section view of the slider in FIG. 32;

FIG. 52 is a top view of the fiber optic connector in FIG. 32 showing the engagement of the carrier with the housings;

FIG. 53 is a left side perspective view of a partial cross section showing the latches and the slider of the fiber optic connector in FIG. 32;

FIG. 54 is a top left side perspective view of a partial cross section showing the latches, the lever and the slider of the fiber optic connector in FIG. 32;

FIG. 55 is a top left side perspective view of a partial cross section showing the lever in a maximum compression;

FIG. 56 is a top perspective view of another embodiment of a fiber optic connector according to the present invention showing the turning element rotating in an axis orthogonal to the fiber optic connector axis; and

FIG. 57 is a perspective view showing the fiber optic connector in FIG. 56 to be removed from the adapter.

### DETAILED DESCRIPTION OF THE INVENTION

Reference will now be made in detail to the present preferred embodiment(s) of the invention, examples of which are illustrated in the accompanying drawings. Whenever possible, the same reference numerals will be used throughout the drawings to refer to the same or like parts.

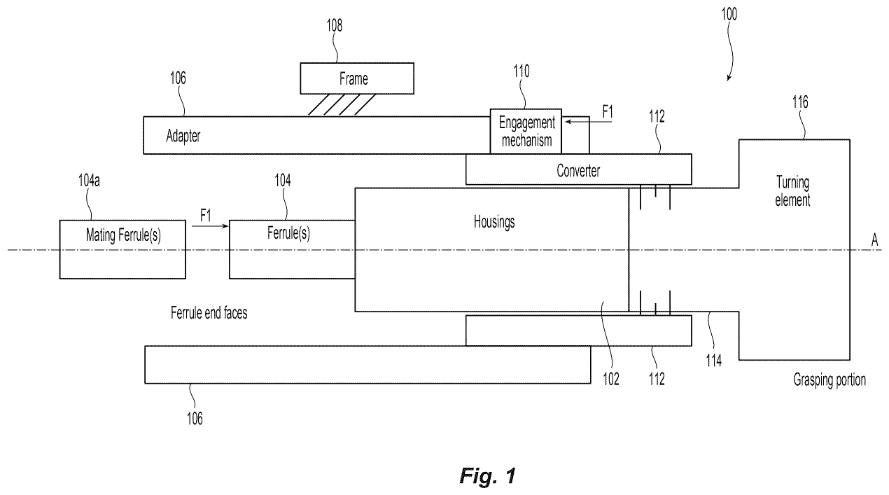

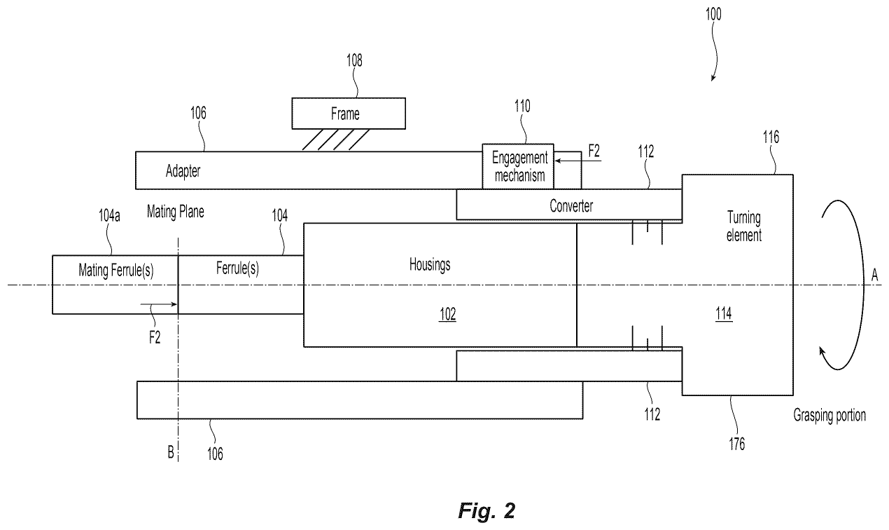

Illustrated in FIGS. 1 and 2 illustrates a schematic diagram of an overall setup for reducing the forces experienced by the end user according to various aspects of this disclosure. In this setup, the fiber optic connector 100 includes a housing 102 that holds one or more fiber optic ferrules 104. There may be a plurality of housings 102 with respective fiber optic ferrules 104 forming a ganged fiber optic connector 100. As is known, the fiber optic ferrule 104 supports one or more optical fibers. For example, the fiber optic ferrule in an LC connector is a single fiber ferrule, whereas in an MDC connector, there are two optical fiber ferrules each supporting one fiber, and further in the MPO and MMC connectors, each ferrule supports at least two (and preferably 8-16) optical fibers arranged in one or more fiber arrays or rows. As such, the setup shown in FIGS. 1 and 2 is applicable to all connector styles such as MDC, SC, FC, MMC, MTP® connector, MPO connector, and the like, or combinations thereof within an adapter.

As shown, each fiber optic ferrule 104 mates with another fiber optic ferrule 104a, referred to herein as a “mating fiber optic ferrule.” FIG. 1 shows a stage in the mating process when the fiber optic connector 100 on the right side has been inserted into an adapter 106 but has not yet mated with the mating fiber optic ferrule 104a on the other side of the adapter 106. The fiber optic connector 100 typically engages with an adapter 106 via an engagement mechanism 110. The fiber optic connector 100 along with the adapter 106, as well as the mating fiber optic ferrule 104a may jointly be referred to as an optical assembly. Such an optical assembly may have more than one mating fiber optic ferrules 104a and/or more than one opposing mating fiber optic connectors. Such engagement mechanism 110 could be, for example, a latch with a window in the adapter 106 to receive the latch. Other types of engagement mechanisms such as latches inside the adapter (e.g., in MPO adapters) could be used too. Alternatively, the locations of the latch and the window may be reversed or swapped between the fiber optic connector 100 and the adapter 106. The adapter 106 may typically be attached to a frame or a panel 108 containing several such adapters 106. Further, engagement between the adapter 106 and the fiber optic connector 100 may occur on both sides of the fiber optic connector 100 or only on one side (as shown), as well as on the top and bottom or sides of the adapter 106. It is preferred that the features in the adapter 106 that mate to the engagement mechanism 110 in the ganged fiber optic connector 100 are the same that would mate to individual fiber optic connectors. For example, in the case of a ganged MDC connector arrangement, the engagement mechanism 110 would mate to the same window feature that an individual MDC connector would mate to within one of the adapter ports (each port supporting at least one transmit-receive optical pair connection). However, in the case of the ganged design, the fiber optic connector 100 may mate to one or more of the windows and could mate to all of them. This aspect of the design is preferred for several reasons: a new adapter does not need to be created specifically for ganged fiber optic connectors (i.e., the adapter 106 herein is a conventional adapter); a user could use some ports for a ganged fiber-optic connector and some ports for individual fiber-optic connectors; and a user could remove individual fiber-optic connectors and replace with some or all ganged fiber-optic connectors or vice versa. This allows for a mix and match functionality for the end user. Of course, the mating fiber optic connectors could instead be only mating fiber optic ferrules depending on the type of the adapter. Alternatively, all adapters, whether for individual or ganged fiber-optic connectors, could contain a new feature that only mates to the engagement mechanism of ganged fiber-optic connectors. Although such a design is included in this invention, this may not be always preferred because it will require additional space in the adapter.

In addition, the engagement mechanism 110 may not be directly attached to the housing 102 of the fiber optic connector 100. Instead, the engagement mechanism may be attached to a converter 112, which is then attached to the housing 102 or to a connector boot 114 (“boot”). The converter 112 may contain the engagement mechanism 110 on one side and features that interact with the connector boot 114 on the other side (e.g., posts, nubs, threads or a ramp surface) in a longitudinal direction. For example, such a converter 112 may include, but is not limited to, a sleeve that partially surrounds the fiber optic connector 100. When the engagement mechanism 110 is fully engaged with the adapter 106, the converter 112 is strain relieved and fixed relative to the adapter 106. In this respect, the term “strain relieve” refers to the engagement mechanism 110 being locked into the adapter 106 in the initial stages of the process of insertion and mating of the ganged fiber optic connector 100 assembly. The converter 112 and the engagement mechanism 110 provide an anchor point to the end user inserting the overall fiber optic connector 100 into the adapter 106 very early in the insertion process. The engagement mechanism 110 is latched at an adapter opening 184 (or window 184) prior to the fiber optic ferrule 104 mating.

The converter 112 may include threads or a ramp to engage with a connector boot 114 having a turning handle or element 116. Alternatively, the turning element 116 may have the ramp surface to engage features on the converter 112. Although the turning element 116 is described here as being positioned at a rear end of the connector boot 114 (and rearward of the housing), the turning element 116 could be separate from the boot 114. That is, the turning element 116 may be in a front part of the connector boot 114. The turning element 116 is configured to be rotated between a plurality of positions about a longitudinal axis of the fiber optic connector 100. The longitudinal axis A is generally parallel to a mating direction of the fiber optic connector 100. A length of the connector boot 114 and hence the distance of the turning element 116 from the housing 102 or the converter 112 can vary depending upon various factors such as the connector type, panel connector density, and the like.

The thread or the ramped surface can be on either the converter 112 and/or the boot 114. The boot 114 includes grasping portions/turning element (handle/flange) 116 toward a rear end to allow the end user to manipulate the boot 114, as will be explained in more detail with respect to FIGS. 2-24. From a force perspective, the force of the mating fiber optic connectors through the spring load are transferred from the thread of the turning element 116 to the engagement mechanism 110. The grasping portions 116 may project outward away from the longitudinal axis A, or may simply be included as part of a frictional engagement between the boot 114 and the end user such that the material of the connector boot 114 has sufficient friction to allow the end user to rotate the connector boot 114. Further, the turning element 116 could be integrated into a connector boot 114. Alternatively, the turning element 116 may be a separate piece that may be attached (e.g., screwed onto) a rear end of the connector boot 114 to achieve the same functionality and the same result. In any case, the connector boot 114 may be turned to push the housing 102 and the fiber optic ferrule 104 towards the mating ferrule 104a. Although the turning element 116 with a thread or a ramp is shown, other mechanical advantage solutions are possible such as levers, which are discussed with respect to other embodiments herein.

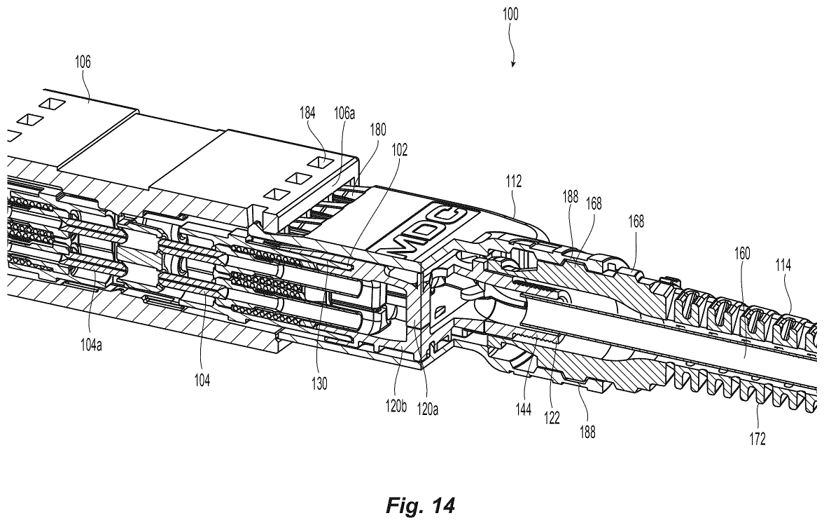

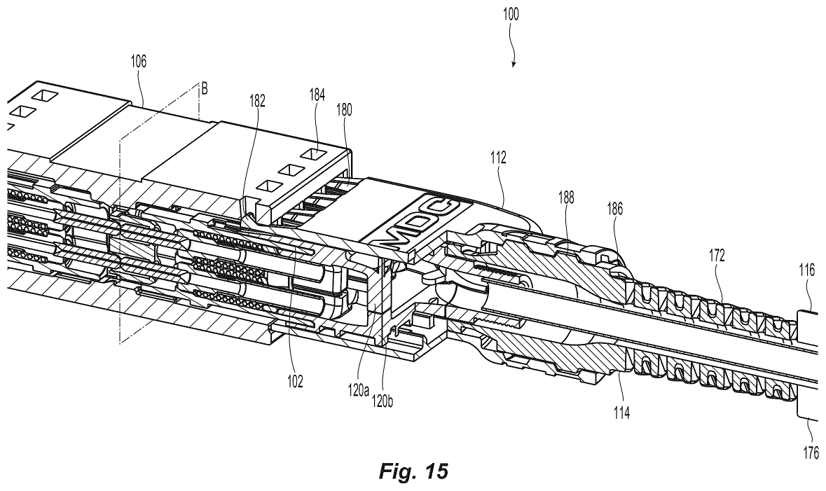

In the initial stage of mating shown in FIG. 1, the fiber optic ferrule 104 may see a force (“F1”) at an end face thereof. This force F1 is less than the final mating force in the position shown in FIG. 2). For example, F1 could be the force from a split sleeve (e.g., FIGS. 14-15) if the fiber optic ferrule 104 were a single fiber ferrule or the force from engaging a guide pin if the ferrule were a multifiber ferrule. Typically, the fiber optic ferrules 104,104a would not be contacting at this stage. Even if they were contacting, the force would be less than the final mating force.

FIG. 2 illustrates a subsequent stage towards a final optical mating position of the two fiber optic ferrules 104,104a. Rotating the turning element 116 (illustrated by the example curved arrow) moves the turning element towards the mating plane B until features of the converter 112 can no longer move relative to the connector boot 114, and the turning element 116 cannot move farther longitudinally (corresponding to maximum rotation of the boot 114). Once the turning element 116 is fully rotated, the housing 102 cannot move any farther forward relative to the converter 112 in the mating direction. If there is a compression spring between the fiber optic ferrule 104 and the turning element 116 (e.g., inside the housing 102 and behind the fiber optic ferrule 104), the force applied to the fiber optic ferrule 104 will increase as the spring is compressed. It is also possible there is no fiber optic ferrule spring on the right side of the adapter, but instead a compression spring is present on the left side. If so, the force would increase as the spring of the mating ferrule 104a is compressed as the fiber optic ferrule 104 on the right is urged forward due to the rotation of the turning element 116. Once the boot 114 is fully rotated (maximum turning), the end face of the fiber optic ferrule 104 on the right experiences a force F2, which is greater than the force F1 shown in FIG. 1. Therefore, the turning element 116 allows for a rotational motion from a low external force (e.g., from a user) to result in a translational (longitudinal) motion of the fiber optic ferrule 104 for mating with the mating ferrule 104a. Due to the presence of the thread or the ramps, the end user encounters significantly lower forces required to push the fiber optic connector 100 inside the adapter 106 for mating. The thread or ramp surfaces generate a high axial force from the torque resulting from the rotation of the boot 114, which translates to high linear forces on the end faces of the fiber optic ferrules 104,104a. As a result, the use of a rotational screw-like mechanism to apply longitudinal mating force is more ergonomic when several such fiber optic connectors 100 are mated. To un-mate the fiber optic ferrules 104,104a, the boot 114 may be turned in an opposite rotational direction, bringing it back to a position as shown in FIG. 1.

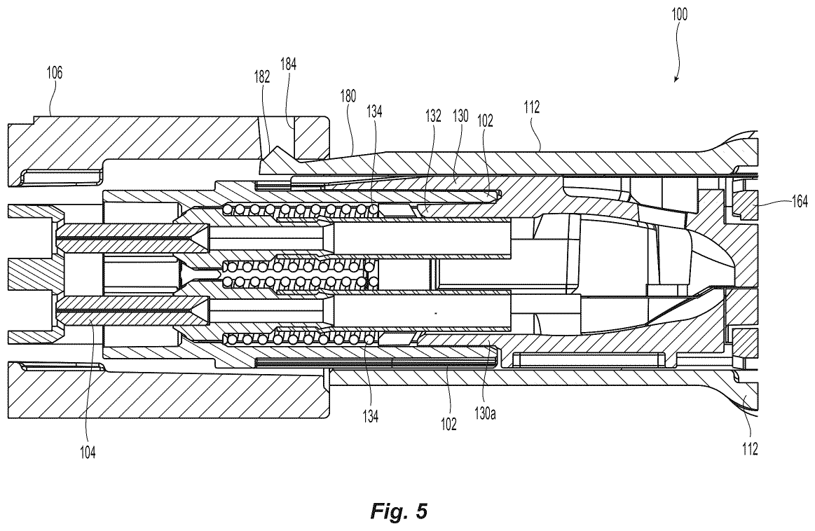

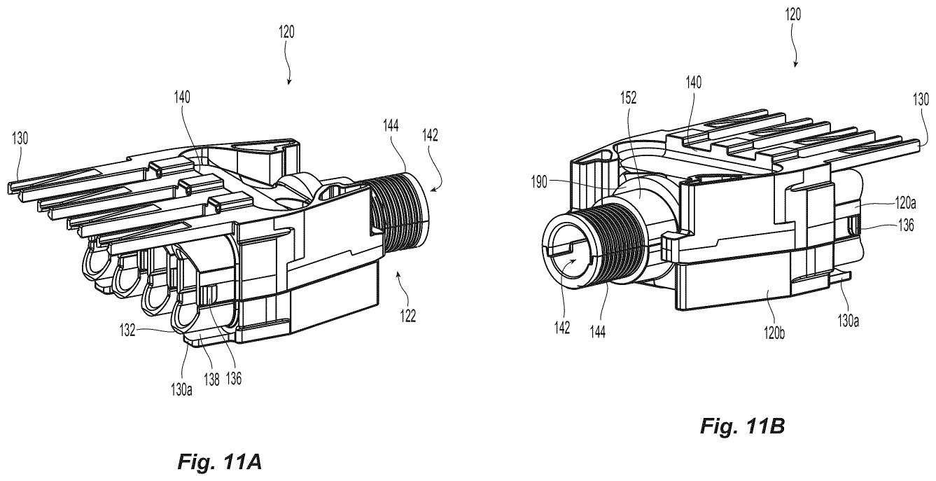

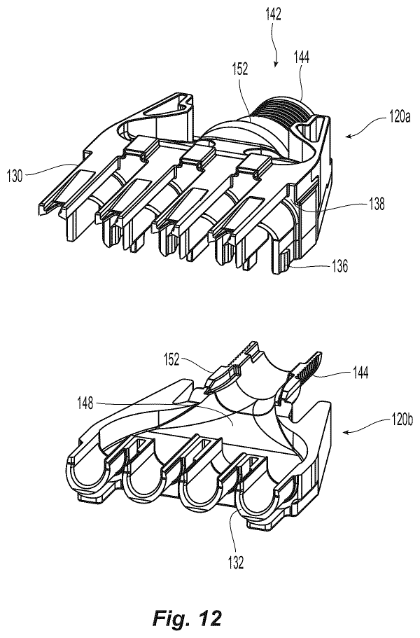

FIGS. 1-15 illustrate one embodiment of a fiber optic connector 100 according to the present invention. The fiber optic connector 100 may be a single fiber optic connector or a ganged plurality of fiber optic connectors as mentioned above. The fiber optic connector 100 includes a fiber optic ferrule 104 supporting at least one optical fiber terminated at a front end 118 of the fiber optic ferrule 104. There is also a housing 102 that at least partially surrounds the fiber optic ferrule 104. The housing 102 is in turn connected to a carrier 120 that supports the fiber optic connector 100 through the carrier 120. In some embodiments, the carrier 120 may also have a crimp body 122 as a portion of the carrier 120. See, e.g., FIGS. 11 and 12. The carrier 120 is engaged with a rearward portion of the housing 102. See, e.g. FIGS. 5 and 13-15. The carrier 120 is illustrated in FIGS. 11 and 12 as being two pieces, upper portion 120a and a lower portion 120b. The carrier 120 may take on different configurations (e.g., a clam-shell like arrangement), as well as being sectioned in different manners from that shown.

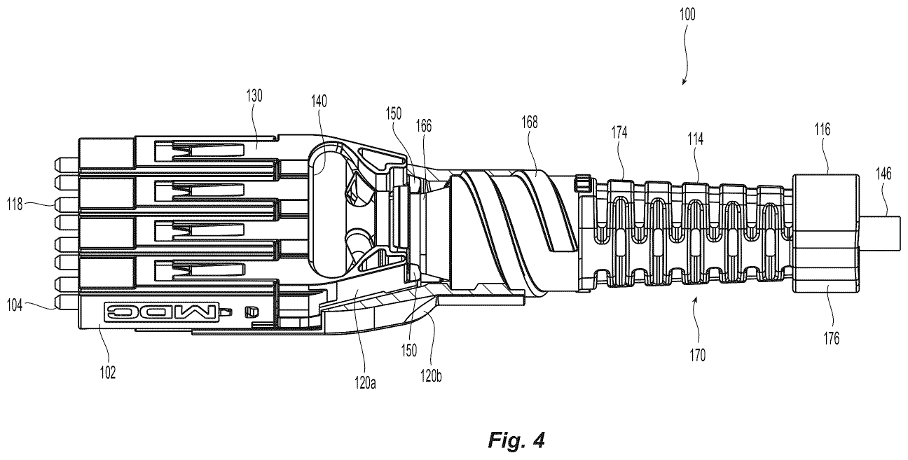

Moving rearwardly on the fiber optic connector 100 is a connector boot 114 coupled to the carrier 120 at a rear portion of the carrier 120. There is also a converter 112 coupled to the connector boot 114 at a front portion of the connector boot 114. See FIG. 4. The converter 112 also has an engagement mechanism 110 to engage with the adapter 106. As indicated before, the fiber optic connector 100 mates with fiber optic ferrules 104a on the other side of the adapter 106, i.e., on an opposite side of the adapter in a longitudinal direction. While the fiber optic ferrules 104a may be in other fiber optic connectors, the fiber optic ferrules 104a may be attached to or disposed within other structures such as a transceiver module or fiber optic ferrule holders without being fully connectorized inside a fiber-optic connector housing (similar to the housing 102). The other fiber optic connectors may also be individual or ganged in groups.

In this embodiment, the connector boot 114 also acts as the turning element 116 and is movable rotationally between a plurality of positions with a torque about the longitudinal axis A. The torque generates a longitudinal force on the converter 112 and on the carrier 120, the longitudinal force being transferred to the fiber optic ferrule 104 as a mating force for mating with the at least one another fiber-optic ferrule 104b.

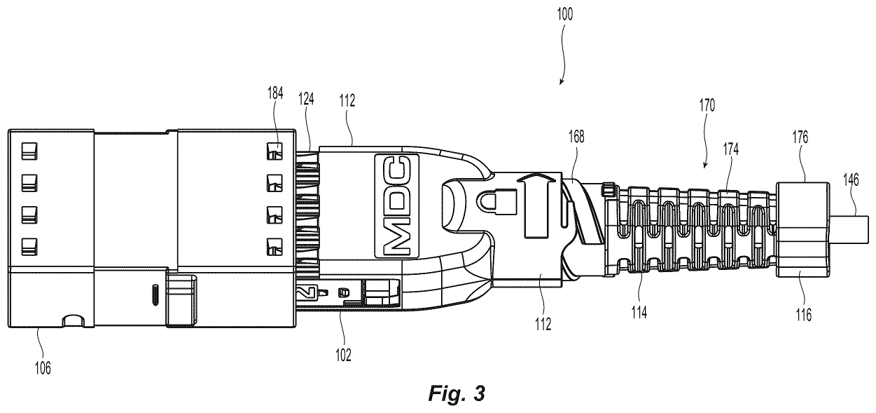

Turning to each of these elements, the following details of the construction and use will be described. The fiber optic ferrules 104 (and 104a) have been discussed above. As noted, the MDC fiber optic connector from the Applicant has been illustrated in the aforementioned '531 publication. The housings 102 for the fiber optic connector 100 are also disclosed in that publication and incorporated by reference herein. While there are four individual fiber optic connectors illustrated in the drawings that make up the fiber optic connector 100, there may be more or fewer individual fiber optic connectors that are ganged together to form the fiber optic connector 100. It should be noted however, that the top of the housings 102 have a rail 124 (see, e.g., FIG. 3) to receive parts of the converter 112 and the carrier 120, which is discussed in detail below.

The carrier 120, seen in FIGS. 4-5 and 11-12, keeps the individual housings 102 together for insertion into the adapter 106. Each housing 102 corresponds to one port of the adapter 106. There are locking extensions 130 on the top of the carrier 120 that fit within the rails 124. The locking extensions 130 may also be on the bottom of the carrier 120 to allow for the carrier 120 to be installed in either direction in the fiber optic connector 100. As illustrated, there are smaller extensions 130a that help in retaining the housings 102. The locking extensions 130 are disposed above an integrated spring push 132, which engages springs 134 that bias the fiber optic ferrules 104 forward in the fiber optic connector. See FIGS. 5, 11A, 11B. There are also tabs 136 that engage openings in the housings 102 to retain the housings 102 in alignment with the carrier 120. There is a space 138 between the integrated spring push 132 and the locking extensions 130 and the smaller extensions 130a to receive a portion of the housing 102 for each of the individual fiber optic connectors. The housings 102 make contact with the carrier 120 in the space 138 and provide another surface to push on the housings 102. See FIGS. 5 and 14-15.

Behind the locking extensions 130 and the integrated spring pushes 132 is a rear-facing surface that is a converter stop plane 140. There is a converter stop plane 140 on at least one of the upper portion 120a and a lower portion 120b. The converter 112 has, as discussed below, a surface 192 that makes contact with the converter stop planes 140 to prevent movement of the carrier 120 and the housings 102 (and therefore the fiber optic ferrules 104) after the carrier 120 and housings 102 have been moved longitudinally.

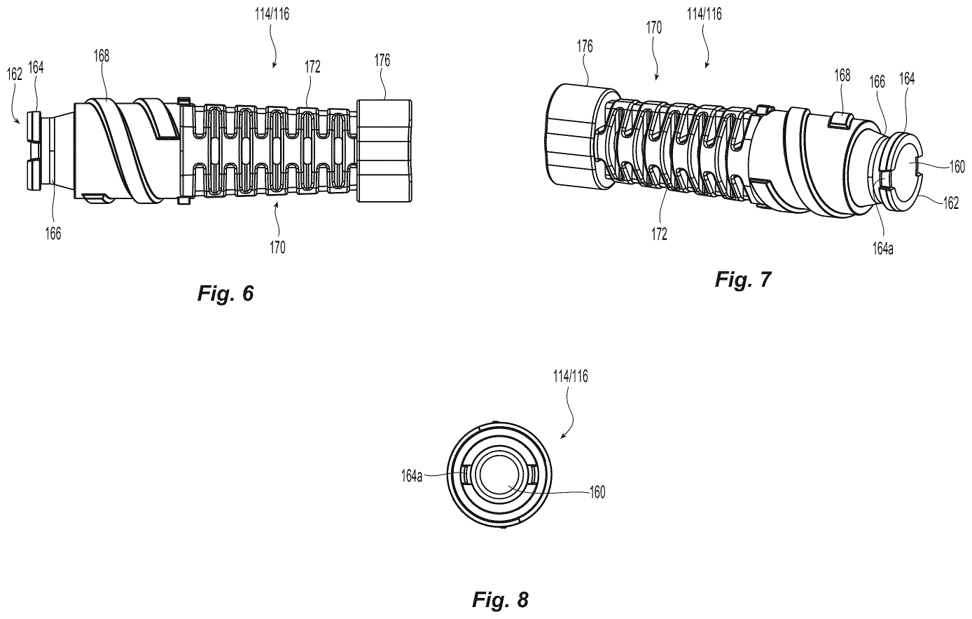

The carrier 120 has at a rear end 142 thereof a crimp portion 144 to crimp the fiber optic cable 146 (see FIG. 3). Between the crimp portion 144 and the converter stop planes 140 is a transitional area 148 for a gentle routing of the optical fibers between the fiber optic cable 146 and the fiber optic ferrules 104 so as to avoid breakage of the optical fibers. On the outside of the carrier 120 in front of the crimp portion are two latches 150 that engage a front portion of the boot 114 to mount the boot on the carrier 120. The boot 114 has a groove 166 around the periphery (see FIGS. 6-8) in which the latches 150 fit allowing the boot 114 to freely rotate about the longitudinal axis A but have limited or no linear motion along the longitudinal axis A relative to the carrier 120. There is a circular collar 152 in front of the crimp portion 144 that more closely matches an inside diameter of the boot 144 to provide more support thereto.

Turning to FIGS. 5-8, the boot 114/turning element 116 is illustrated. The boot 114 is generally cylindrical with a central opening 160 for the fiber optic cable 146 to pass therethrough. The front 162 has a lip 164 and then the groove 166 to receive the latches 150 from the carrier 120. The lip 164 may be sectioned with slots 164a not being around the full circumference to allow for clearance of the latches 150 during assembly. Behind the groove is a section with a helical projection 168 that wraps around the boot 114. The helical projection 168 engages a portion of the converter 112 to move the converter 112 in a longitudinal motion along the longitudinal axis A. As discussed below, there are other configurations that are possible and come within the scope of the claimed invention. For example, the curved projection 168 could be on the converter 112 and the boot 114 could have a corresponding curved groove to still achieve the same effect. Also there may only be a small projection that is disposed opposite the curved groove and not an elongated curved projection 168 as illustrated in FIGS. 6 and 7, with such small projection riding inside the curved groove. Additionally, instead of a single small projection, there may be multiple of such projections.

A middle portion 170 has a ribbed portion 172 that provides strain relief for the fiber optic cable 146. The rear end 174 has a grasping portion 176 where the user can rotate the boot 114 to initiate the rotation that causes the longitudinal movement of the fiber optic ferrules 104.

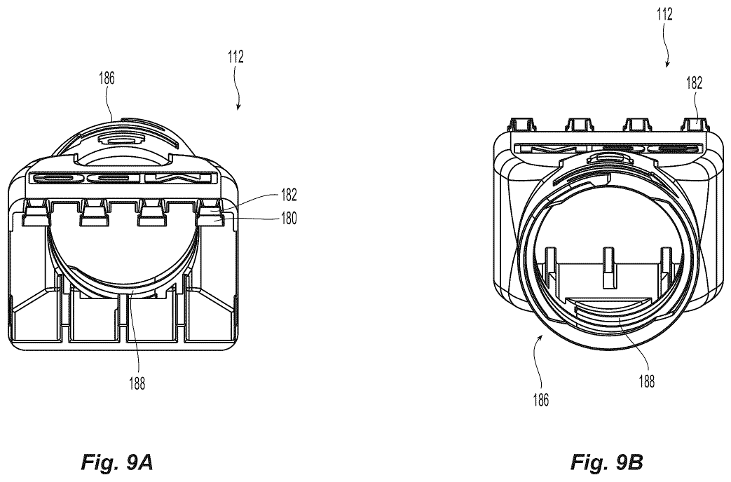

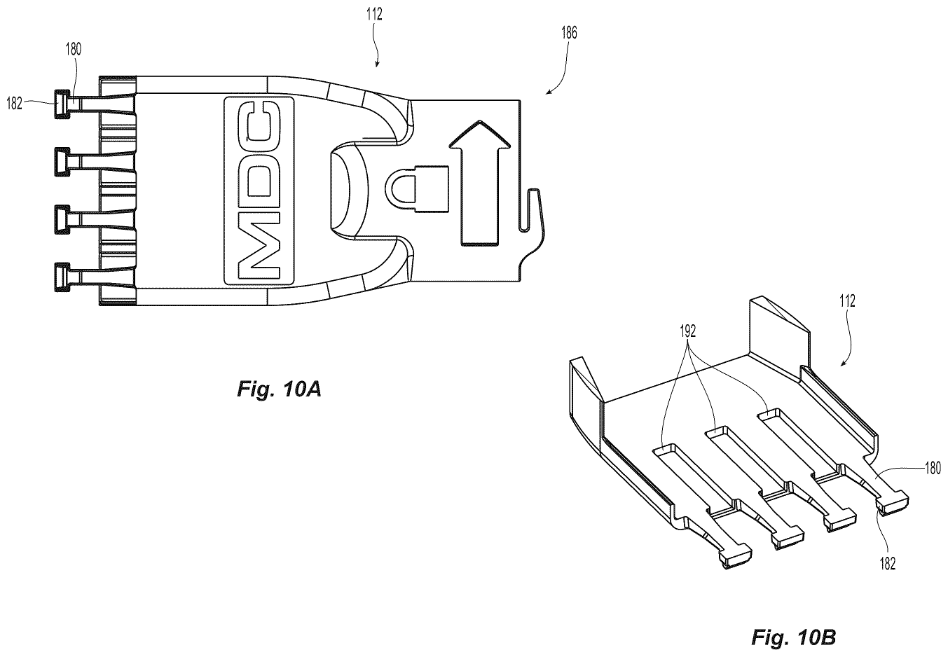

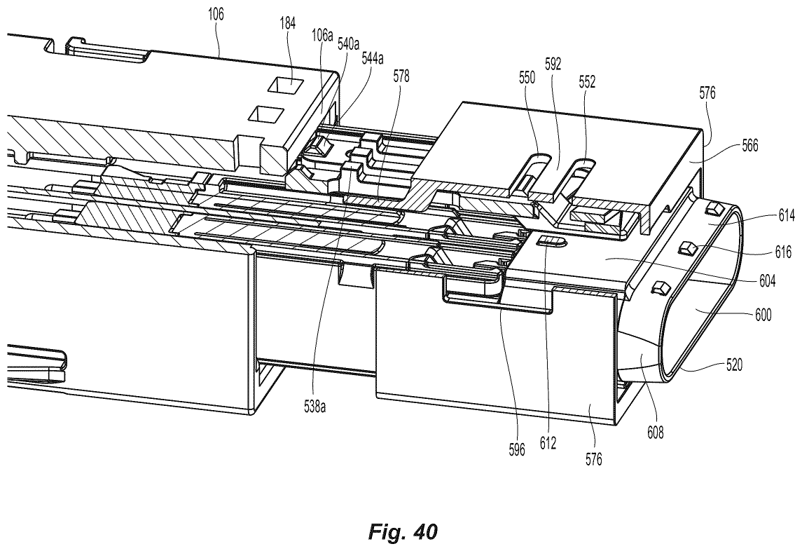

The converter 112 is illustrated in FIGS. 9A, 9B, and 10A, and 10B. The converter 112 is disposed over the carrier 120 (and the crimp body 122) and the housings 102 so that a majority of the carrier 120 is not visible to the user. See FIG. 3. Extending from the front of the converter 112 are four engagement mechanisms 110—which in the embodiment are formed by elongated projections 180 with a chamfered bump 182 at the ends of each of the elongated projections 180. The spacing of the elongated projections 180 matches the rails 124 on the housings 102 and the locking extensions 130 on the carrier 120. The chamfered bump 182 at the ends of each of the elongated projections 180 are to be inserted into the four openings 184 in the adapter 106. Before the fiber optic connector 100 is inserted into the adapter 106, the elongated projections 180 extend beyond the locking extensions 130 on the carrier 120. This allows for the elongated projections 180 to be deflected towards the rails 124 upon initial contact with a rear facing surface 106a during insertion into the adapter 106. See, e.g., FIG. 40 for the rear facing surface 106a. The deflection of the elongated projections 180 occurs due to their flexible/cantilevered arrangement. Once the chamfered bump 182 enters the openings 184, the elongated projections 180 move away from the rails 124 to a position inside the openings 184.

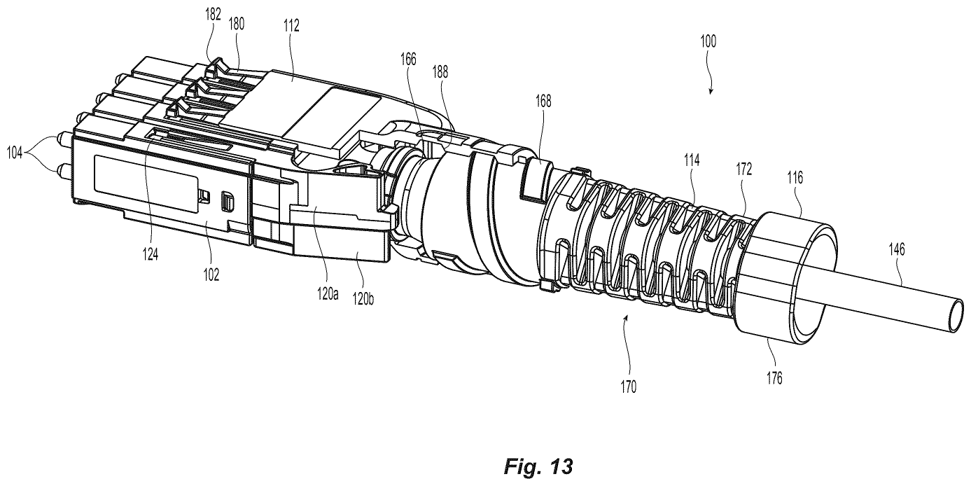

The rear end 186 of the converter 112 has a circular configuration to receive the boot 114 (and the fiber optic cable 146) therethrough. On the inside of the rear end 186 is a helical groove 188 that has the same helical configuration as the helical projection 168 on the boot 114. A final position of the rotation of the boot 114 is determined by a surface at a front end of the helical projection 168 that is blocked by an end surface at the front end of the helical groove 188. Converter stop plane 140 making contact with surface 192 limits rearward longitudinal motion of the connector boot 114 relative to the carrier 120 during removal of the fiber optic connector 100 from the adapter 106. See, e.g., FIG. 13 for the surface at a front end of the helical projection 168. On the inside surface of the converter 112 are forward facing surfaces 192 that engage the rear-facing surface/converter stop plane 140.

When the fiber optic connector 100 is assembled, the carrier 120 is attached to the housings 102, the converter 112 is added from the rear to cover the carrier 120. The boot 114 is then added by inserting it into the rear end 186 of the converter 112. The latches 150 are disposed within the groove 166. At this point, the front part of the helical projection 168 on the boot 114 engages the helical groove 188 in the converter 112. The fiber optic connector 100 is then ready to be inserted into the adapter 106. See FIG. 13.

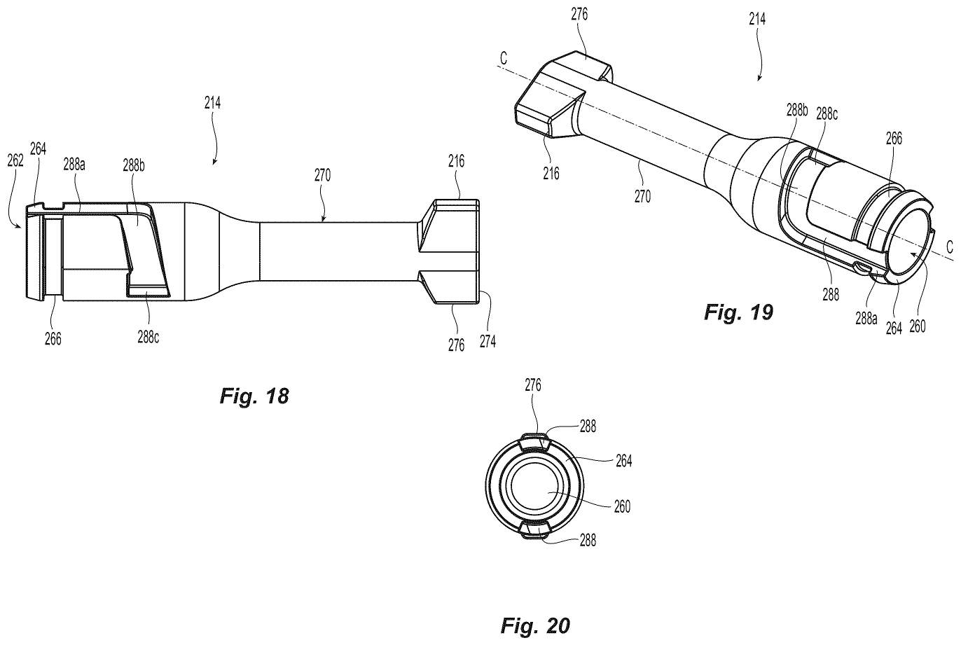

The helical projection 168 and the helical groove 188 together form a thread like mechanism to transfer forces due to the rotational motion of the boot 114 to longitudinal forces on the carrier 120 and the housings 102, and therefore to the fiber optic ferrules 104. It will be appreciated by one of ordinary skill in the art after reading this disclosure that instead of a helical geometry, other curved or part linear-part curved shapes for the projection 168 and groove 188 may be used (see, e.g., FIGS. 18-20).

After the fiber optic connector 100 is first inserted into the adapter 106, the elongated projections 180 are deflected into the rails 124 as they and the chamfered bumps 182 engage the rear facing surface 106a of the adapter 106. Continued forward motion allows the chamfered bumps 182 to enter the openings 184 and the elongated projections 180 to move out of the rails 124. See FIGS. 5 and 14. At this point, there is still free space under the chamfered bumps 182 and above the rails 124 (see, e.g., FIG. 5), and the engagement mechanism 110 is at this point at an initial anchor point with the adapter 106. This assists with controlling the remaining insertion process of the fiber optic connector 100 until the final mating position of the fiber optic ferrules 104.

When the turning element 116 is turned about the longitudinal axis A, the engagement of boot lip 164 contacting the carrier push plane 190 causes the carrier 120 to move forward—the torque from the rotational movement through a plurality of positions causes the forward motion of the carrier 120. As the carrier 120 moves forward, the locking extensions 130 move into the space under the elongated projections 180 within the adapter 106 wedging the elongated projections 180 and the chamfered bumps 182 in the adapter 106. Thus, the locking extensions 130 lock the chamfered bumps 182 inside the respective openings 184, and therefore the converter 112 cannot accidentally dislodge from the adapter 106 (which would cause an issue with the optical connection as the fiber optic connector 100 would then dislodge or have an unsecure position inside the adapter 106). Continued turning moves the fiber optic ferrules 104 into a mating plane B and in mating contact with the other fiber optic ferrules 104a. See FIGS. 2 and 15. It is also possible that the fiber optic connector 100 is completely inserted into the adapter 106 before the other fiber optic ferrules 104a are positioned within the adapter 106. In that scenario, due to the internal springs inside the housings 102, the fiber optic ferrules 104 move back slightly under forces from the respective mating fiber optic ferrules 104a. The user may remove the fiber optic connector 100 from the adapter 106 by turning the turning element 116 in the opposite direction about the longitudinal axis A. This causes the locking extensions 130 to retreat from and free up the space underneath the chamfered bumps 182. A pull from the user can then cause the locking extensions 130 to bend towards the rails 124, thereby allowing removal of the fiber optic connector 100 from the adapter 106. Although the above description includes the use of ramped latches (chamfered bumps 182) and locking extensions 130, other latching mechanisms could be used to anchor the fiber optic connector 100 to the adapter 106. For example, a latch that has a front facing ramp and a vertical rear facing surface, commonly referred to as a “dead latch” could be used in conjunction with a latch release mechanism that disengages the dead latch. This type of latch is used in SC, MU, and MDC fiber optic connectors.

According to one aspect of this disclosure, a method for mating the fiber optic connector 100 inside the adapter 106 is provided. The term “mating” herein refers to forming an optical connection between at least two fibers. Such mating may involve physically mating the end faces of single fiber ferrules or multi-fiber ferrules. The end faces may be straight polished or angled polished, as is known to one of ordinary skill in the art. Alternatively, when the ferrules are lensed, there may be a gap between the end faces even though an optical connection may still be formed. The process of mating begins with an initial anchoring of the fiber optic connector 100 to the openings 184 of the adapter 106. As discussed, the chamfered bumps 182 position inside the openings 184 for this step of the method, which happens after the elongated projections 180 deflect due to contact with the rear facing surface 106a of the adapter 106 as the user pushes the fiber optic connector 100 into the adapter 106. The term “anchoring” herein refers to the entry of the chamfered bumps 182 inside the openings 184, which stabilizes an initial alignment of the ganged housings 102 with the adapter 106 for the user. Once the anchoring step is complete, the turning element 116 is actuated by the user. Such actuation includes rotating the boot 114 around the longitudinal axis A of the fiber optic connector 100. As the boot 114 rotates, helical projections 168 travel within helical grooves 188 to bring the boot 114 closer to the mating plane B.

Simultaneously, the rotation translates to a longitudinal force on the carrier 112 through the boot lip 164 contacting the carrier push plane 190 which then pushes the housings 102 in a forward direction towards the mating plane B inside the adapter 106.

Thus, the method allows for applying lower rotational forces to the boot 114 by the user (via the turning element 116) than would be needed if the user were applying linear forces to mate the fiber optic connector 100.

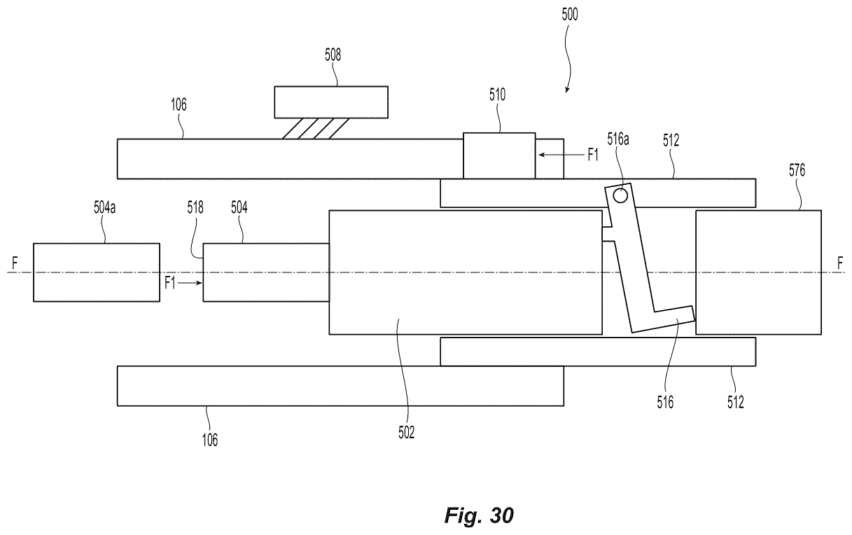

These rotational forces may be applied in other planes and at other locations too to provide a mechanical advantage to the user. For example, as described with respect to FIG. 30 onwards, a rotational motion of a lever arm may assist the user to multiply the forces to achieve the same mechanical advantage as above.

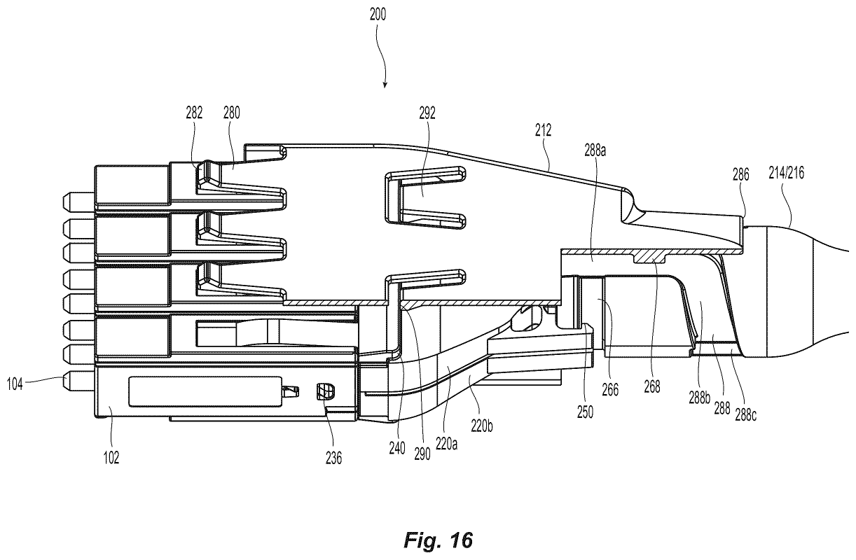

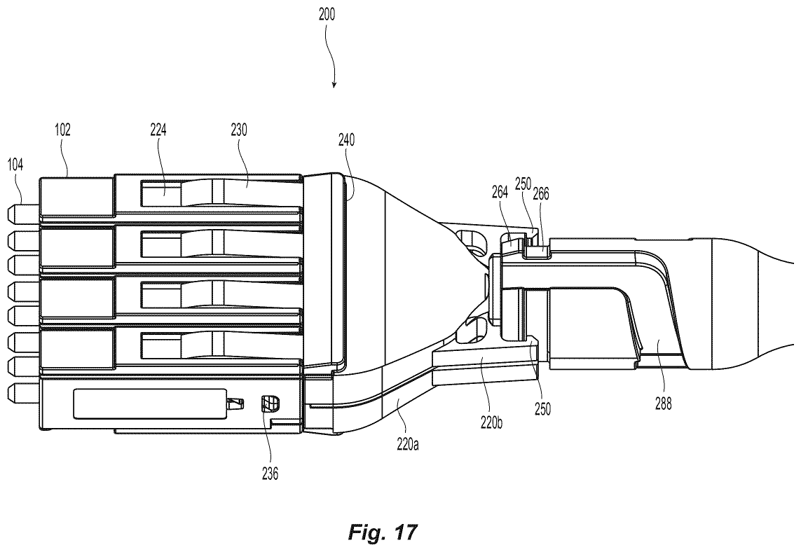

Another embodiment of a fiber optic connector 200 according to the present invention is illustrated in FIGS. 16-24. In this embodiment, the fiber optic connector 200 has the groove 288 on the boot 214/216 and the projection 268 on the inside of the converter 212. See FIGS. 16 and 17.

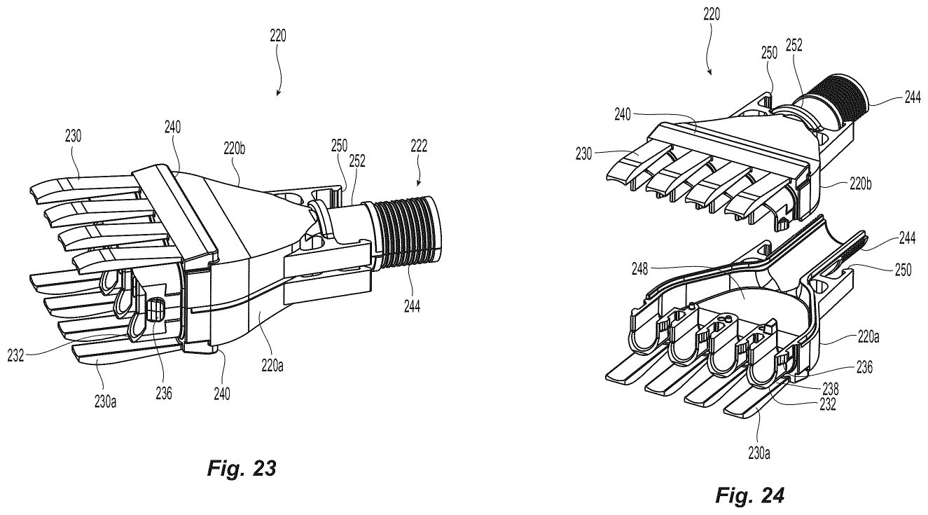

The boot 214/turning element 216 is illustrated in FIGS. 18-20. The boot 214 is generally cylindrical with a central opening 260 for the fiber optic cable 146 to pass therethrough. The front 262 has a lip 264 and then a groove 266 to receive the latches 250 from a carrier 220 (see, FIGS. 23-24). Extending from the front 262 rearwardly are two grooves 288 on diametrically opposed sides of the boot 214 that each receive a projection 268 therein from the converter 212. A first portion 288a of the groove 288 is generally straight and parallel to the longitudinal axis C. The first portion 288a allows for the boot 214 to be pushed into the fiber optic connector 200 to engage the carrier 220. As the turning element 214 is turned, the projection 268 on the converter 212 follows the second arcuate portion 288b. There is also provided a locking portion or recess 288c, where the projection 268 engages the boot 214 to prevent the turning portion 216 from turning back the other way and possibly allowing for an uncoupling of the fiber optic connector 200. While the second portion 288b is illustrated as arcuate, it could have other similar shapes, e.g., curved, helical, etc.

A middle portion 270 provides strain relief for the fiber optic cable 246. The rear end 274 has a grasping portion 276 where the user can grasp the turning element 216.

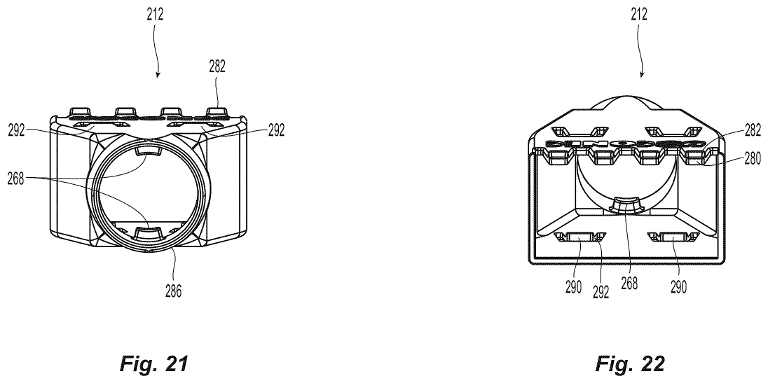

The converter 212 is illustrated in FIGS. 21-22. The converter 212 is disposed over the carrier 220 (and the crimp body 222) and the housings 102 so that a majority of the carrier 220 is not visible to the user. The converter 212 also has four engagement mechanisms 110—which in the embodiment are formed by elongated projections 280 with a chamfered bump 282 at the ends of each of the elongated projections 280. The spacing of the elongated projections 280 matches the rails 224 on the housings 202 and the locking extensions 230 on the carrier 220. The chamfered bump 282 at the ends of each of the elongated projections 280 are to be inserted into the four openings 184 in the adapter 106. Before the fiber optic connector 200 is inserted into the adapter 106, the elongated projections 280 extend beyond the locking extensions 230 on the carrier 120. This allows for the elongated projections 280 to be deflected towards the rails 224 upon initial contact with a rear facing surface 106a during insertion into the adapter 106. See again, e.g., FIG. 40 for the rear facing surface 106a. Again, the deflection of the elongated projections 280 occurs due to their flexible/cantilevered arrangement. Once the chamfered bump 282 enters the openings 184, the elongated projections 280 move away from the rails 124 to a position inside the openings 184.

The rear end 286 of the converter 212 has a circular configuration to receive the boot 214 (and the fiber optic cable 146) therethrough. On the inside of the rear end 186 are two projections or nubs 268 to engage the groove 288 on the boot 214. Also, on the inside surface of the converter 212 are forward facing surfaces 290 that engage the rear-facing surface/converter stop plane 240. See FIG. 16. The forward facing surfaces 290 are formed by tabs 292 that are connected on one side to the converter 212. As shown, there are two of these surfaces 290 on each side of the converter 212, but there could be more or even fewer.

The carrier 220, seen in FIGS. 23 and 24, keeps the individual housings 102 together for insertion into the adapter 106. There are locking extensions 230 on the top of the carrier 220 that fit within the rails 224. The locking extensions 230a may also be on the bottom of the carrier 220 to allow for the carrier 220 to be installed in either direction in the fiber optic connector 200. The locking extensions 230/230a are disposed above and below an integrated spring push 232, which engages springs inside the housings 102 that bias the fiber optic ferrules 104 forward in the fiber optic connector. There are also tabs 236 that engage openings in the housings 102 to retain the housings 102 in alignment with the carrier 220. There is a space 238 between the integrated spring push 232 and the locking extensions 230/230a to receive a portion of the housing 102 for each of the individual housings 102. The housings 102 make contact with the carrier 220 in this space and provide another surface to push on the housings 102.

Behind the locking extensions 230 and the integrated spring pushes 232 is a rear-facing surface that is a converter stop plane 240. There is a converter stop plane 240 on both the upper portion 220a and a lower portion 220b. The converter 212 has forward facing surfaces 290 that make contact with the converter stop planes 240 to move the carrier 220 and the housings 102 (and therefore the fiber optic ferrules 104) in a translational/longitudinal motion for mating with the mating ferrule 104a.

The carrier 220 has at a rear end 242 thereof a crimp portion 244 to crimp the fiber optic cable. Between the crimp portion 244 and the converter stop planes 240 is a transitional area 248 for the routing of the optical fibers between the fiber optic cable and the fiber optic ferrules 104 while maintaining a safe bend radius for the optical fibers. On the outside of the carrier 220 in front of the crimp portion are two latches 250 that engage a front portion of the boot 214 to mount the boot 214 on the carrier 220. The boot 214 has a groove 266 around the periphery (see FIGS. 18-19) in which the latches 250 fit allowing the boot 214 to rotate freely about the longitudinal axis A but have limited movement parallel to the longitudinal axis A. There is a circular collar 252 in front of the crimp portion 244 that more closely matches an inside diameter of the boot 244 to provide more support thereto.

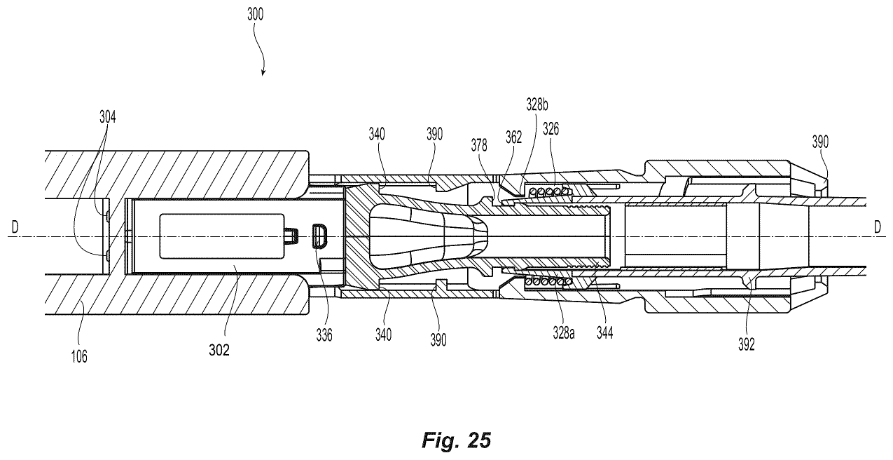

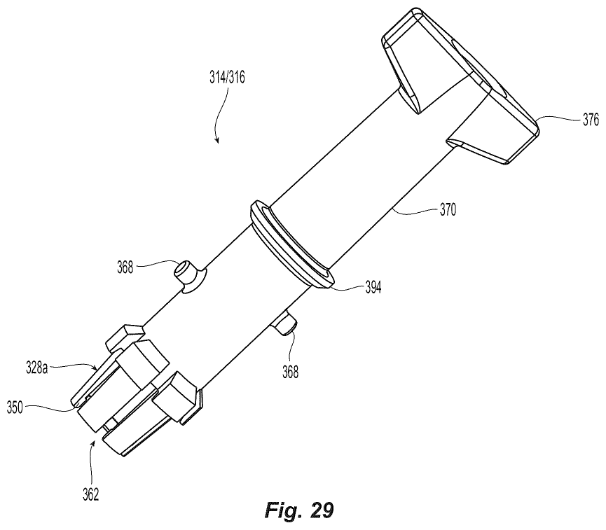

Another embodiment of a fiber optic connector 300 according to the present invention is illustrated in FIGS. 25-29. In this embodiment, the fiber optic connector 300 has grooves 388 on the inside of the converter 312 and the projection 368 on boot 314/316. See FIGS. 28 and 29.

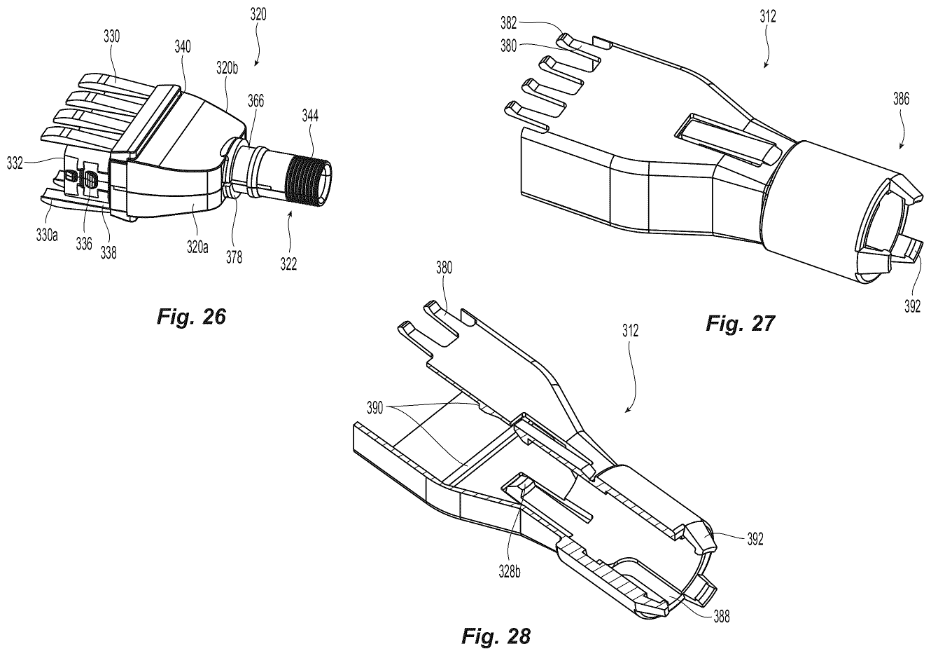

The fiber optic connector 300 has a carrier 320, seen in FIGS. 25 and 26, similar to the other carriers. That is there are locking extensions 330/330a on the carrier 320 to engage the housings 102. The locking extensions 330/330a are disposed above and below an integrated spring push 332, which engages springs that bias the fiber optic ferrules 104 forward in the fiber optic connector. There are also tabs 336 that engage openings in the housings 102 to retain the housings 102 in alignment with the carrier 320. There is a space 338 between the integrated spring push 332 and the locking extensions 330/330a to receive a portion of the housing 102 for each of the individual fiber optic connectors. The housings 102 make contact with the carrier 320 in this space 338 and provide another surface to push on the housings 102.

Behind the locking extensions 330 and the integrated spring pushes 332 is a rear-facing surface that is a converter stop plane 340. There is preferably a converter stop plane 340 on both the upper portion 320a and a lower portion 320b of the carrier 320. The converter 312 has forward facing surfaces 390 that make contact with the converter stop planes 340 to move the carrier 320 and the housings 102 (and therefore the fiber optic ferrules 104) in a translational/longitudinal motion for mating with the mating ferrule 104a.

The carrier 320 has a crimp body 322 with a crimp portion 344 to crimp the fiber optic cable. On the outside of the carrier 320 and in front of the crimp portion 344 is a groove 366 to receive the latches 350 at the front end 362 of the boot 314 (FIG. 29) to mount the boot on the carrier 320. The groove 366 and the latches 350 allow the boot to freely rotate about the longitudinal axis D but not move much at all along the longitudinal axis D.

The boot 314/turning element 316 is illustrated in FIG. 29. The front 362 has the latches 350 to engage the carrier 320 as noted above. Extending from the boot 314/turning element 316 are two projections 368 to engage the grooves 388 on the converter 312. Again, there are grooves 388 on diametrically opposed sides of the converter 312 that each receive a projection 368 therein. The turning of the boot 314 causes the converter 312 and the carrier 320 to move longitudinally due to the rotation of the boot. A middle portion 370 provides strain relief for the fiber optic cable. The rear end has a grasping portion 376 where the user can grasp the turning element 316.

The converter 312 is illustrated in FIGS. 27-28. The converter 312 is disposed over the carrier 320 (and the crimp body 322) and the housings 102 so that a majority of the carrier 320 is not visible to the user as in the prior embodiments. The converter 312 has similar elongated projections 380 with a chamfered bump 382 at the ends of each of the elongated projections 380. As noted above, the converter 312 has forward facing surfaces 390 that make contact with the converter stop planes 340 to move the carrier 320 and the housings 102. The rear end 386 of the converter 312 has a circular configuration to receive the boot 314 (and the fiber optic cable) therethrough. There are three boot retaining latches 392 to engage the rear stop 394 on the boot 314 to keep the boot 314 from exiting the converter 312. See FIG. 29.

As can be gleaned from FIG. 25, there is a spring 326 that engages a spring cradle 328a on the boot 314. The spring cradle 328a has a forward facing surface that seats the spring 326. The spring 326 also makes contact with the spring retaining latch 328b (FIG. 28) to bias the boot 314 toward the rear end 386 of the converter 312. As with the other embodiments, the rotation of the boot 314 causes the converter 312 and the carrier 320 to move longitudinally along the longitudinal axis D due to engagement of the projection 368 in the converter grove 388. However, the initial insertion of the fiber optic connector 300 into the adapter 106 uses the front 362 of the boot 314/316 to push against a carrier push plane 378 on the carrier 320. See FIGS. 25 and 26.

The movement of the fiber optic connectors (100,200,300) may also be effectuated by using a different method than the rotational movement about a longitudinal axis that is translated into longitudinal movement by a turning element. Rather, it is also possible to use a lever to gain the mechanical advantage in moving the fiber optic connectors into a mating position.

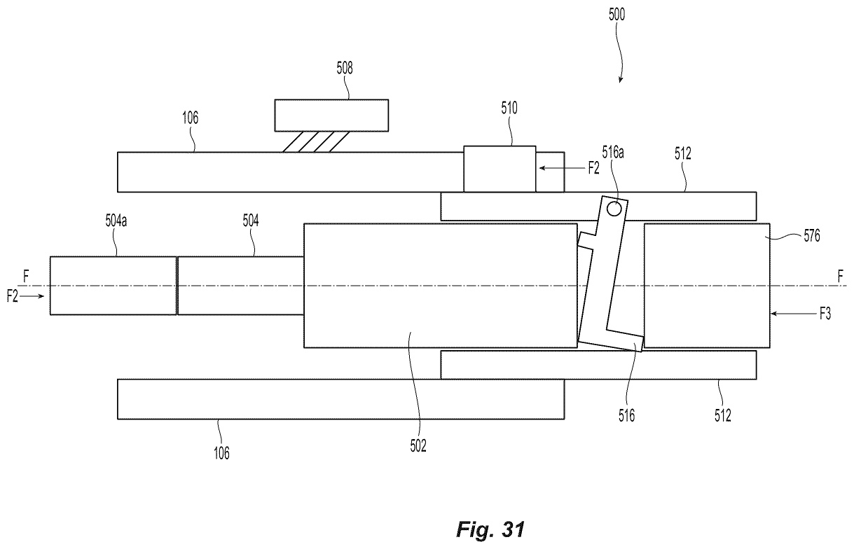

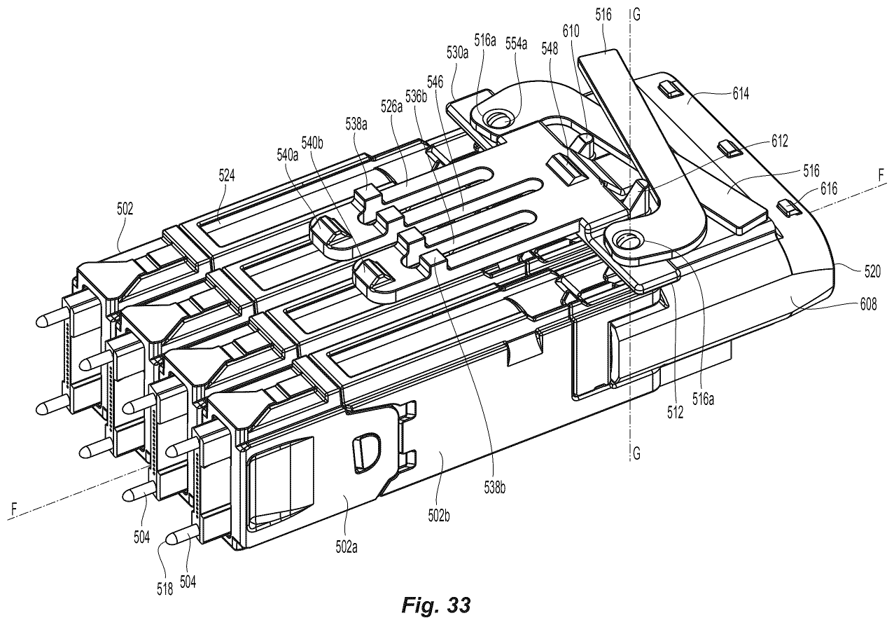

As with the prior embodiments, the concept is illustrated using FIGS. 30 and 31. These figures are a schematic diagram of an overall setup for reducing the forces experienced by the end user according to various aspects of this disclosure. Here as well, the fiber optic connector 500 includes a housing 502 that holds one or more fiber optic ferrules 504. There may be a plurality of housings 502 with respective fiber optic ferrules 504 forming a ganged fiber optic connector 500. The fiber optic ferrules 504 in the following embodiments are the same as noted above, thus there is no need to repeat that discussion. As discussed above, the engagement mechanism 510, converter 512 and the carriers 520 perform substantially the same actions as described above in detail. The housing 502 holding each fiber optic ferrule 504 is a two-piece housing with a front piece (cap) and a rear piece (body), although the two pieces may be combined into a single piece as an alternative. Details of how the two pieces are attached and how the fiber optic ferrule 504 is positioned inside the housing 502 are provided in Applicant-owned International Patent Publication No. WO 2021/217050 (Atty. Dkt. USCO- 131-INT, hereinafter “the '050 publication”), which is incorporated herein by reference and will not be described further. The difference in the following examples and embodiments is that the movement of the fiber optic ferrules 504 are effectuated by a lever about an orthogonal axis parallel to a plane containing the short sides of the housings 502, rather than a rotational element about a longitudinal axis. See axis G in FIG. 33.

As shown, each fiber optic ferrule 504 mates with another fiber optic ferrule 504a, referred to herein as a “mating fiber optic ferrule.” FIG. 30 shows a stage in the mating process when the fiber optic connector 500 on the right side has been inserted into an adapter 106 but has not yet mated with the mating fiber optic ferrule 504a on the other side of the adapter 106. The fiber optic connector 500 typically engages with an adapter 106 via an engagement mechanism 510. Such engagement mechanism 510 could be, for example, a latch with a window in the adapter 106 to receive the latch. Other types of engagement mechanisms 510 such as latches inside the adapter 106 (e.g., in MPO adapters) could be used too. Alternatively, the locations of the latch and the window may be reversed or swapped between the fiber optic connector 500 and the adapter 106. The adapter 106 may typically be attached to a frame or a panel 508 containing several such adapters. Further, engagement between the adapter 106 and the fiber optic connector 500 may occur on both sides of the fiber optic connector 500 or only on one side (as shown), as well as on the top and bottom or sides of the adapter 106.

In addition, the engagement mechanism 510 may not be directly attached to the housing 502 of the fiber optic connector 500. Instead, the engagement mechanism 510 may be attached to a converter 512, which is then attached to the housing 502 or to a connector boot 514 (“boot”). The converter 512 may contain the engagement mechanism 510 on one side and an anchor point or a pivot point for a lever 516 on the other side. When the engagement mechanism 510 is fully engaged with the adapter 106, the converter 512 is strain relieved and fixed relative to the adapter 106. The converter 512 and the engagement mechanism 510 provide an anchor point to the end user inserting the overall fiber optic connector 500 into the adapter 106 very early in the insertion process. As a result, this reduces the chances of incorrect insertion or misalignment, and ensures accurate positioning of the fiber optic connector 500 for successful mating operations later on in the process.

In the initial stage of mating shown in FIG. 30, the fiber optic ferrule 504 may see a force (“F1”) at an end face thereof. This force F1 is less than the final mating force (in the position shown in FIG. 31). For example, F1 could be the force from a split sleeve if the fiber optic ferrule 504 was a single fiber ferrule or the force from engaging a guide pin if the fiber optic ferrule 504 was a multifiber ferrule. Typically, the fiber optic ferrules 504, 504a would not be contacting at this stage. Even if they were contacting, the force would be less than the final mating force. At the end of this stage, the engagement mechanism 510 is actuated and held in the adapter 106 with the ability to resist the mating force of the ferrules 504, 504a.

FIG. 31 illustrates a subsequent stage towards a final optical mating position of the two fiber optic ferrules 504,504a. The user interface 576 is the component that the user pushes on to insert the fiber optic connectors 500 and actuate the lever 516. As discussed below, that component may be a slider 576. The user interface could also be a boot, a stick, a push pull tab, or any other connector component. As the user interface 576 is pushed, the lever 516 rotates about the pivot point 516a, as such is rotating about an orthogonal axis G parallel to a plane containing the short sides of the housings 502. Consequently, the force applied to the housing 102 is multiplied. The lever 516 shown is a simple lever with the pivot point 516a outside the location that the force is applied by the user and the location the force is applied to the housing 102. However, similar concepts are applicable for curved levers, multiple linkages, or pivot points in between the input and output forces (i.e., behind the user interface). Although the pivot point 516a shown here is on the converter 512, the pivot point 516a could easily be moved to the housing 502 or even the user interface 576 with similar results. In all these cases, the converter 512 must be strain relieved to the adapter 106 through the engagement mechanism 510.

If there were a compression spring between the fiber optic ferrule 504 and the user interface 576 (e.g., inside the housing and behind the ferrule), the force applied to the fiber optic ferrule 504 will increase as the spring is compressed. It is also possible there is no fiber optic ferrule spring on the right side of the adapter 106, but instead a compression spring on the left side. If so, the force would increase as the spring of the mating fiber optic ferrule 504a is compressed as the fiber optic ferrule 504 is urged forward. Once the fiber optic ferrules 504,504a are fully mated, the end face of the fiber optic ferrule 504 experiences a force F2, which is greater than the user applied force F3 shown in FIG. 31. Force F3 is shown parallel to the longitudinal axis F, but in other instances with different lever 516 orientations, force F3 may also not be parallel to the longitudinal axis F. Therefore, the lever 516 allows for a force multiplication from a low force F3 (e.g., from a user) to result in a translational motion of the fiber optic ferrule 504 for mating with the mating fiber optic ferrule 504a. Due to the presence of the lever 516, the end user sees significantly lower forces required to push the fiber optic connector 500 inside the adapter 106 for mating, in contrast to a scenario where there was no force multiplication provided due to the lever 516 (and hence, no mechanical advantage) and the user had to provide all the 40N and above forces for mating.

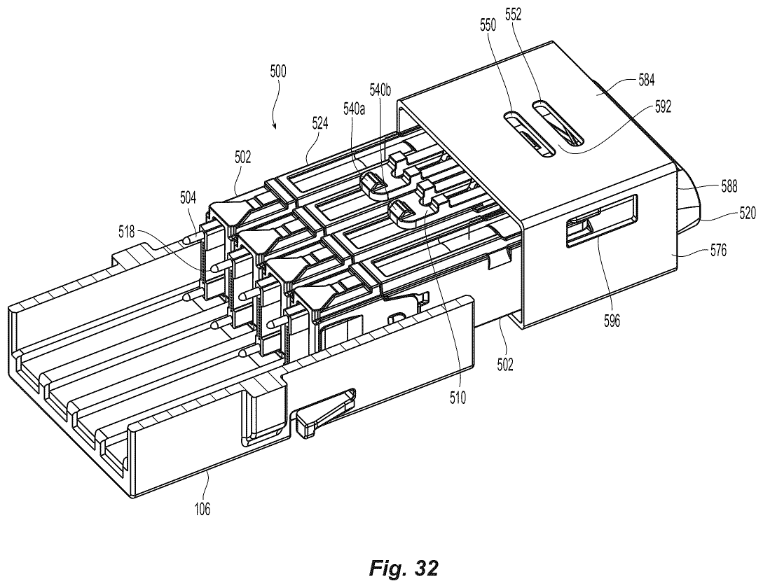

FIGS. 32-55 illustrate one embodiment of a fiber optic connector 500 according to the present invention. The fiber optic connector 500 includes a fiber optic ferrule 504 supporting at least one optical fiber terminated at a front end 518 of the fiber optic ferrule 504. The fiber optic connector 500 includes a housing 502 partially surrounding the fiber optic ferrule 504. While four such housings 502 are shown, more or less may be provided. Of course, for a fiber optic connector to be referred to as “ganged,” at least two housings 502 will be provided. There is also a turning element or lever 516 located rearward of the housing 502 and a converter 512 coupled to the turning element 516 at a front portion of the turning element 516 and having an engagement mechanism 510 to engage with the adapter 106. As noted above, the turning element 516 moves rotationally orthogonally (axis G) to a longitudinal axis F along the fiber optic connector 500 between a plurality of positions to exert a longitudinal force to the fiber optic ferrule 504, whereby the fiber optic ferrule 504 moves between a first longitudinal position to a second longitudinal position in response to the longitudinal force. See FIGS. 30, 31, and 34. It will be appreciated by one of ordinary skill in the art after reading this disclosure that other forms of force multiplication mechanisms could be provided. For example, a combination of rotatory gears in a cam-like mechanism may be used.

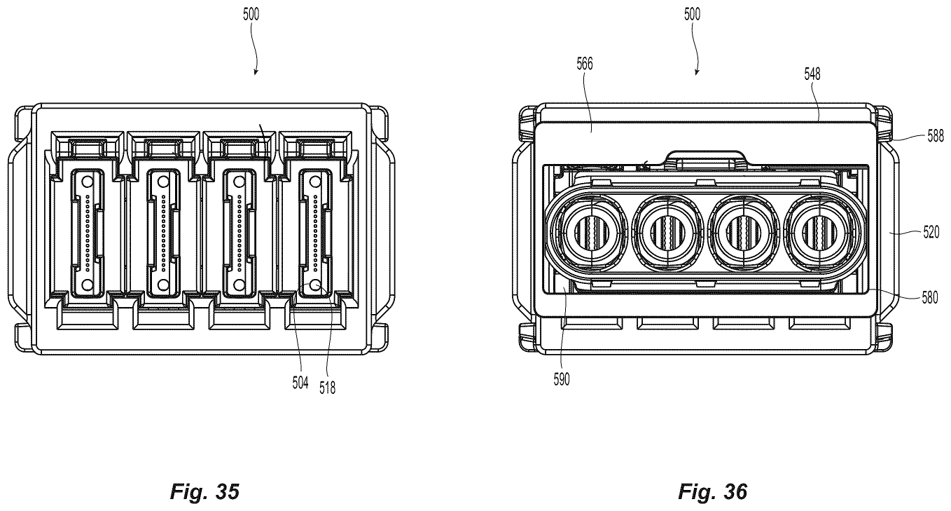

As illustrated, the housing 502 holding each fiber optic ferrule 504 is a two-piece housing 502 with a front piece 502a (cap) and a rear piece 502b (body), although the two pieces may be combined into a single piece as an alternative. Details of how the two pieces are attached and how the fiber optic ferrule 504 is positioned inside the housing 502 are provided in the aforementioned '050 publication, and will not be described further herein. The four housings 502 are commonly attached to a carrier 520 at a rear end of each of the housings 502. Each housing 502 has a front footprint that corresponds to a SFP-DD or a QSFP-DD footprint standard known in the industry. See, e.g., front profile view in FIG. 35, when viewed from an opening of the adapter (where opposing connectors are eventually positioned for mating). FIG. 36 shows the rear profile view of the 4-port ganged fiber optic connector 500 (view from the right side of FIG. 33).

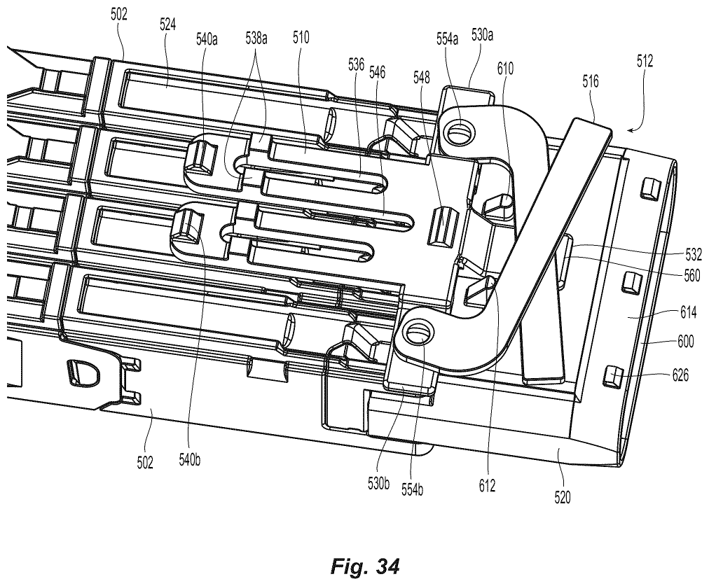

Each housing 502 also has a short side and a long side, but in the example shown, four such short sides of respective housings 502 are positioned side by side to match with a long side of the adapter 106 and a long side of the carrier (See FIGS. 33 and 34). Since the ganged fiber optic connector 500 disclosed herein uses four housings 502 as an example, such a ganged fiber optic connector 500 may also be equivalently referred to herein as a 4-port ganged fiber optic connector 500, i.e., each housing 502 corresponding to a port of connection for the optical link (when mated with another fiber optic connector inside the adapter 106). Similarly, a ganged fiber optic connector 500 with two housings 502 may be referred to as a 2-port ganged fiber optic connector 500.

The housings 502 have rails 524 on the short sides to receive one or more latches or engagement mechanisms 510. These rails 524 are provided on one of the short sides of each housing 502. See, e.g., FIGS. 33 and 34. In the 4-port example shown, two of the inner housings 502 receive a latch 510 having respective latch extensions 526a/526b slidably received in the respective rails 524 of the two inner housings 502. The term “inner” in this context refers to those housings 502 that are not at the sides or ends of the 4-port ganged fiber optic connector 500 when moving along a transverse axis/direction (orthogonal to the mating and un-mating direction of the ganged connector). In contrast the longitudinal direction or longitudinal axis is substantially parallel to the mating and unmating directions of the ganged connector, i.e., along longitudinal axis F. A slider 576 partially covering the latch 510, the carrier 520, and the housings 502 is also shown in FIG. 32. It should be noted that the turning element 516 and the engagement mechanism/latch 510 are on the same structure, the converter 512.

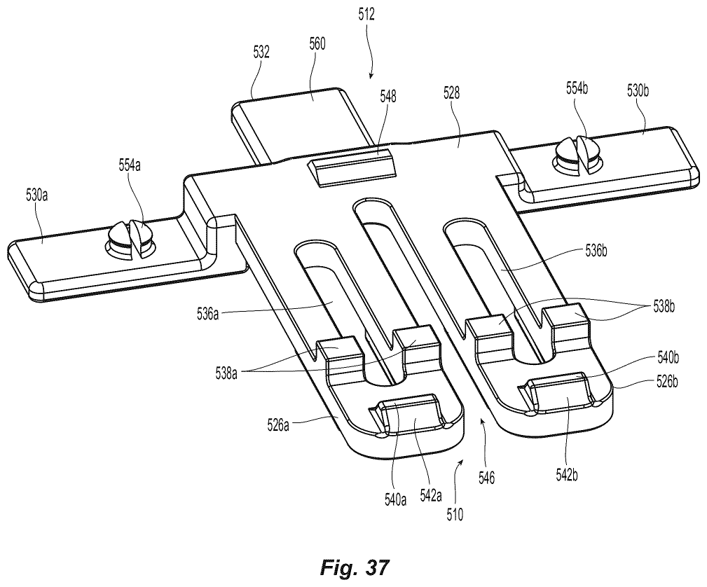

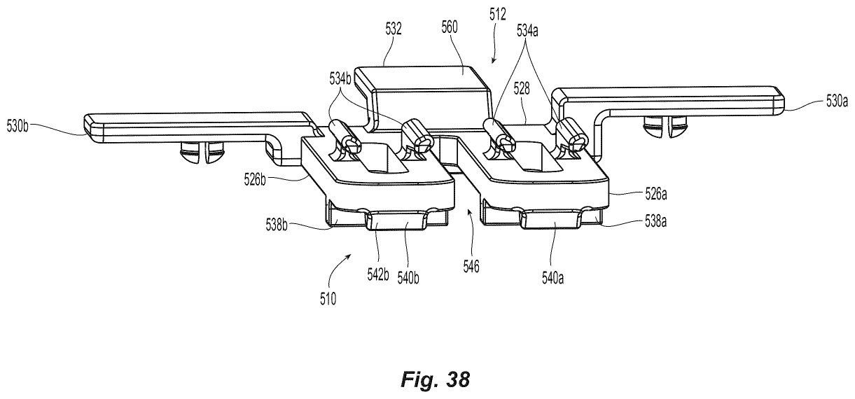

The latch 510 is shown separately in FIGS. 37 and 38 with a top perspective view and a bottom perspective view, respectively. As shown in FIGS. 37 and 38, the latch 510 has a main body 528 and two latch extensions 526a/526b centrally positioned between two latch wings 530a/530b on opposite sides in a transverse direction. The latch extensions 526a/526b extend longitudinally away from the main body 528 and away from a rear end 532 of the latch 510. On each latch extension 526a/526b, guide mechanisms 534a/534b (FIG. 38) are provided to fit inside the guide rails 524 of respective two inner housings 502. The latch extensions 526a/526b each have a longitudinal slot 536a/536b centrally positioned along a length of the latch extension 526a/526b. Each of these longitudinal slots 536a/536b accepts one of the two slider extensions 578 of a slider 576 that is placed around the housings 502 and the carrier 520, at least partially covering these components (see, e.g., FIGS. 40, 43, 44). On a top side of the latch 510, i.e., the side facing away from the housings 502, there are a pair of posts 538a/538b on each of the latch extensions 526a/526b (i.e., four total posts). At a forward most end, also on the top side, each latch extension 526a/526b has a detent 540a/540b. These posts 538a/538b are positioned towards a front end of the latch extensions 526a/526b but rearward of latch detents 540a/540b on each of the latch extensions 526a/526b. The positioning of the posts 538a/538b is selected such that a forward facing surface of each of these posts 538a/538b engages the rear facing surface 106a at an entrance of the adapter 106 (see, e.g., FIG. 40). The detents 540a/540b occupy and are trapped by the four openings 184 in the adapter 106 as the 4-port ganged fiber optic connector 500 is being inserted thereinto. See, e.g., FIGS. 40-42. The detent 540a/540b on each latch extension 526a/526b is aligned with the respective longitudinal slot 536a/536b and forward of the longitudinal slot 536a/536b, such that the respective posts 538a/538b on each latch extension 526a/526b are on opposite sides of the detent 540a/540b, in a transverse direction. Each detent 540a/540b has a forward facing ramp 542a/542b to aid insertion into an opening 184 in the adapter 106, as well as a rear facing ramp 544a/544b to aid removal of the 4-port ganged fiber optic connector 100 from the adapter 106, as will be described in detail below.

The slider extensions 578 engage the bottom side of the latch extensions 526a/526b as the slider 576 is moved forward towards the adapter 106. The latch extensions 526a/526b are separated from each other by a gap 546 that aligns the latch extensions 526a/526b with the guide rails 524 on the top sides of the housings 502 to which each of the latch extensions 526a/526b attach. As shown in FIGS. 37 and 38 for example, the gap 546 extends all the way to the main body 528. Alternatively, the gap 546 may be partially filled such that the latch extensions 526a/526b are joined to each other forward of the main body 528.

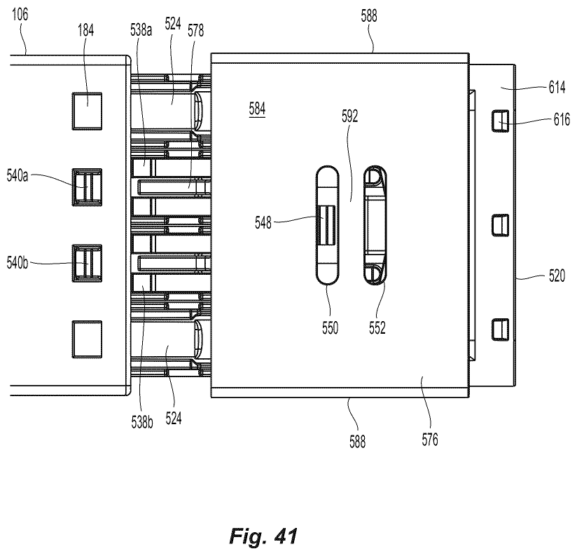

Moving rearward on the latch 510 on the main body 528 and still on the top side, there is a central detent 548 between two laterally/transversally extending wings 530a/530b of the latch 510. The central detent 548 is sized to fit inside a forward slot 550 and a rearward slot 552 at two respective positions of the slider 576, as will also be explained in more detail hereinafter. A first position of the latch 510 relative to the slider 546 is shown, for example, in FIGS. 32 and 41. The central detent 548 can be seen through the forward slot 550 of the slider 520. Moving in a top to bottom direction, the wings 530a/530b are positioned at respective planes lower than and parallel to a plane containing the latch extensions 526a/526b and the central detent 548. One wing 530b is closer to the top surface of the main body than the other wing 530a. This allows for one lever arm 516 to be positioned above the other lever arm 516 without mutual interference between the lever arms 516. As a result, there are two steps formed on opposite sides of the main body 528 from where the wings laterally extend respectively (see, e.g., FIGS. 37-38) an upper step and a lower step. In this context, the wing 530b extending from the upper step may be referred to as an upper wing, and likewise, the wing 530a from the lower step may be referred to as a lower wing. It will be appreciated by one of ordinary skill in the art reading this disclosure that for a smaller ganged fiber optic connector 500 (e.g., a 2-port ganged connector), the wings 530a/530b on each side may be smaller, or even non-existent.

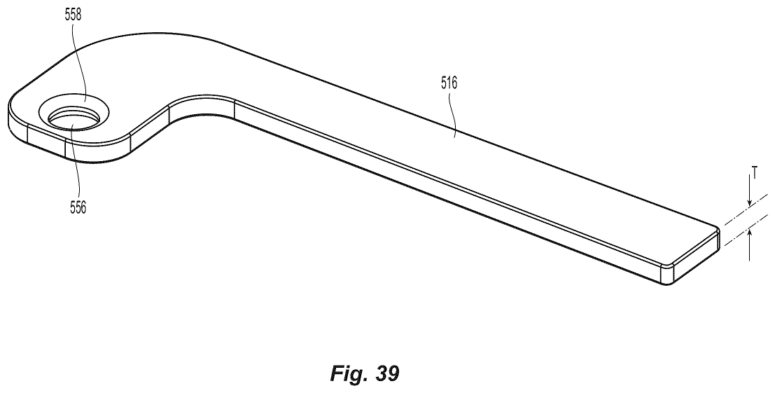

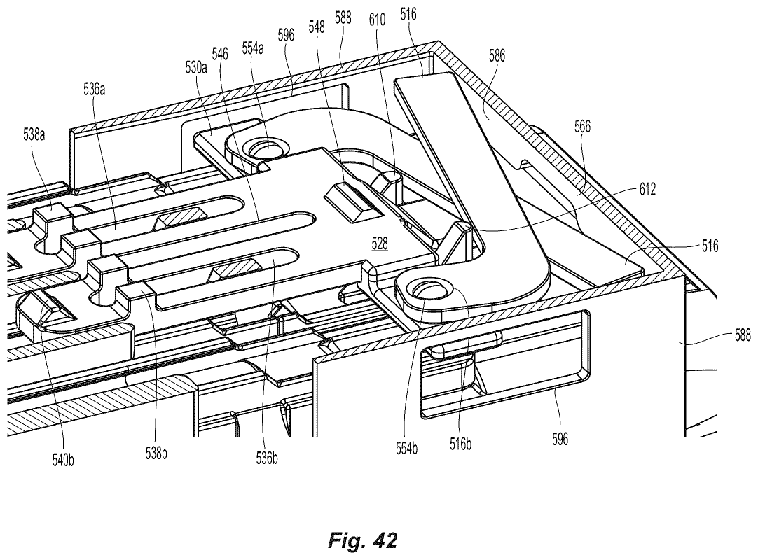

On a top surface of each of the wings, a button 554a/554b is provided. Each button 554a/554b is respectively engageable to an opening 556 of a lever arm 516 (see, e.g., FIG. 33) of a pair of lever arms 516 of the ganged fiber optic connector 500. A bottom side of the opening 556 in each lever arm 516 has a chamfered surface 558 to help guide an engagement with a respective button 554a/554b on the wings 530a/530b of the latch 510. See FIG. 39. Each lever arm 516 is shaped generally in the form of the letter J. Such a J-shape helps avoid any interference between the main body 528 of the latch 510 and the lever arms 516, while also handles the forces better. However, other shapes such as an I-shape may be used as an alternative. The mounting of the lever arm 516 on the latch 510 such that the unsecured end of the lever arm 516 is free, causes the lever arm 516 to flex and be under stress or compress within the slider 520. This generates at least a portion of the forces needed to mate the ganged fiber optic connector 500 inside the adapter 106 to an opposing fiber optic ferrule 504a or to an opposing fiber optic connector(s) (ganged or not). The lever arms 516 each have a top to bottom thickness T designed to position the lever arms between the slider 576 and a tail 560 (see, FIGS. 37 and 38) of the latch 510. That is, when assembled with the ganged fiber optic connector 500, the lever arms 516 cross each other (one above the other) over the tail 560. See, e.g., FIGS. 33 and 34. The tail 560 prevents bending of the lever arms 516 in the vertical or top to bottom direction within the slider 576. See also, the partial cross section of FIGS. 40 and 42.

The lever arms 516 provide a lever mechanism for the 4-port ganged fiber optic connector 500, and are limited or restricted in their rotational or angular movement by two carrier posts 610/612 (forward direction limitation) and an internal surface 564 on a rear wall 566 of the slider 576 (rearward direction limitation, FIG. 42). The lever arms 516 compress between these two structures, as well. That is, each lever arm 516 engages a respective carrier post 610/612 along a forward facing side of the lever arm 516, and engages the rear wall 566 of the slider 576 at a free end of the lever arm 516. To ensure the farthest part of the free end of the lever 516 engages the slider rear wall 566, the lever arm 516 has a variable width. The lever arm 516 is widest on the free end and less wide at the point where it contacts the carrier posts 610/612 described later. Such engagements of the lever arms 516 with the respective carrier posts 610/612 and the internal rear surfaces 564 of the slider 576 may contribute to the multiplication of forces during insertion of the 4-port ganged fiber optic connector 500 relative to the adapter 106.

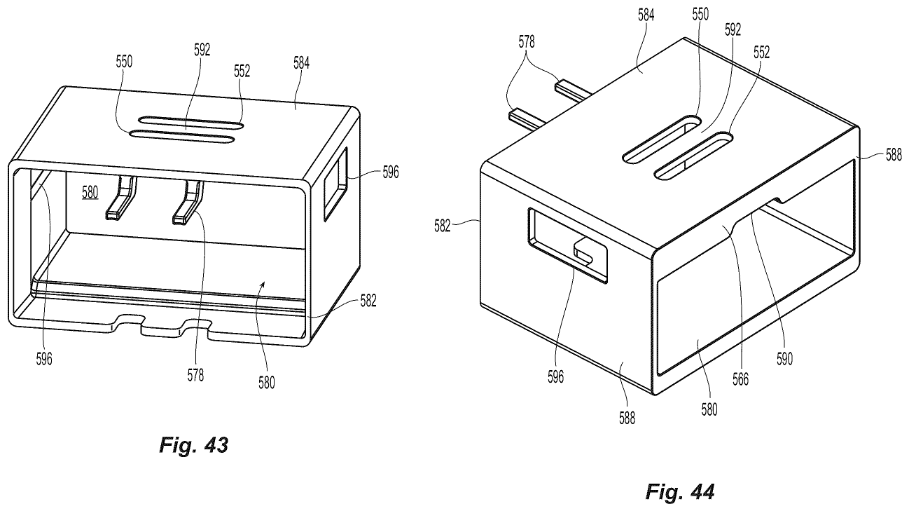

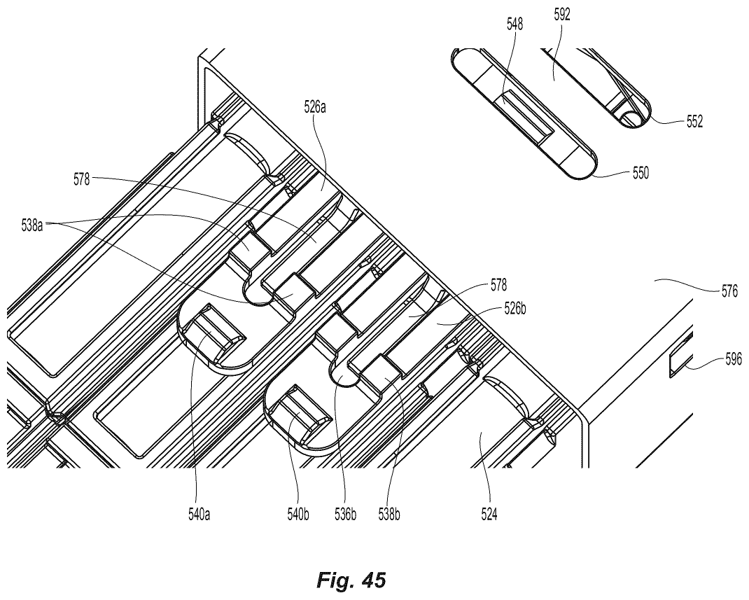

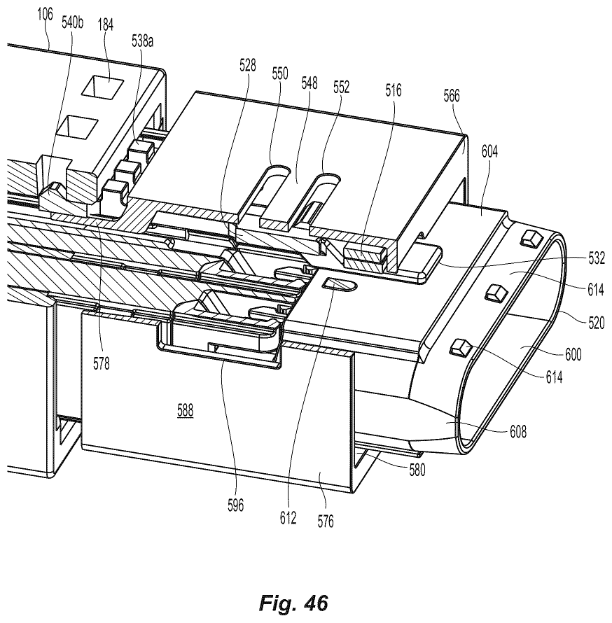

Moving on to the slider 576, the aforementioned components of the 4-port ganged fiber optic connector 500 fit within a profile of the slider 576. See again, FIGS. 32 and 36. As the name indicates, the slider 576 is slid over the boot (not shown) of the ganged fiber optic connector 500 in a direction from rear to forward, and the aforementioned components of the ganged fiber optic connector 500 are enclosed within an opening 580 of the slider 576 in a profile view. FIG. 43 illustrates a front perspective view of the slider 576, and FIG. 44 illustrates a rear perspective view. In FIG. 43, the slider extensions 576 are shown extending downward and away from a front end 582 of the slider 576. The downward extending portion allows the forward extending portion of the slider extension 578 to be positioned below the longitudinal slots 536a/536b of respective latch extensions 526a/526b. See, e.g., FIG. 45. As the slider 576 moves forward, the slider extensions 578 slide over the short sides of the respective inner housing 502 and eventually position underneath a bottom side of the latch detents 540a/540b on the latch extensions (at the front of the latch extensions) 526a/526b. See FIG. 46. Such positioning of the slider extensions 578 prevents the latch detents 540a/540b from popping out of the four openings 184 in the adapter 106, and retains the 4-port ganged fiber optic fiber optic connector 500 securely to the adapter 106. At this point, the central detent 548 on the main body 528 of the latch 510 is inside the rearward slot 552 on a top surface 584 of the slider 576 (see also FIG. 41).

FIG. 44 illustrates a rear perspective view of the slider 576. A rear wall 566 projects downward from the top surface 584. An inner surface 586 of this rear wall 566 of the slider 576 engages the free ends of the lever arms 516, as shown in FIG. 42. Additionally, the lever arms 516 may engage the side walls, but that is not a requirement. The rear wall 566 is shown running between the side walls 588 of the slider 576, and only on the top side. However, the rear wall 566 may not be a continuous structure. That is two smaller disjointed walls, each from a respective side surface may still be able to engage the respective free ends of the lever arms 516. Further, the rear wall 566 is shown as having a non-uniform thickness in the top to down direction (thinner towards the center). A rear wall recess 590 is provided to prevent interference with the tail 560 of the latch 510. See also FIG. 36. However, this too is not a limitation, and the thickness may be uniform or variable, without affecting the function of the rear wall 566, which is to capture the free ends of the lever arms 516. For example, the tail 560 of the latch 510 may be shortened a bit in the longitudinal direction to never interfere with the rear wall 566 of the slider 576.

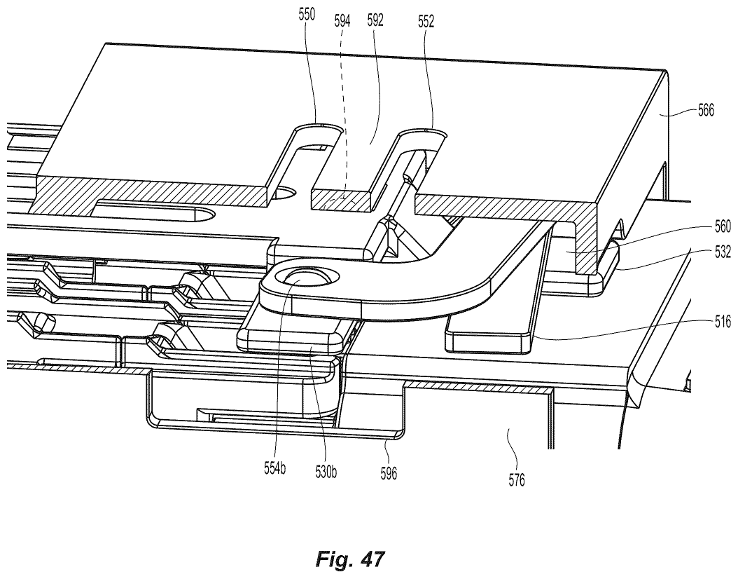

The top surface of the slider 576 has the forward slot 550 and the rearward slot 552 to accommodate the central detent 548 of the latch 510 in the first position and the second position, respectively. The forward and the rearward slots 550/552 may be openings into the slider, or alternatively, may be recesses into the top surface of the slider 576 from inside the slider (conditional on the thickness of the slider). The forward slot 550 and the rearward slot 552 are separated by a bridge 592. An underside of the bridge 592 may have an optional relief feature 594 to aid the sliding of the central detent 548 between the first and the second position. See, e.g., FIG. 47. If the relief feature 594 is absent, the central detent 548 can still slide between the two positions since the bridge 592 may have some compliance.

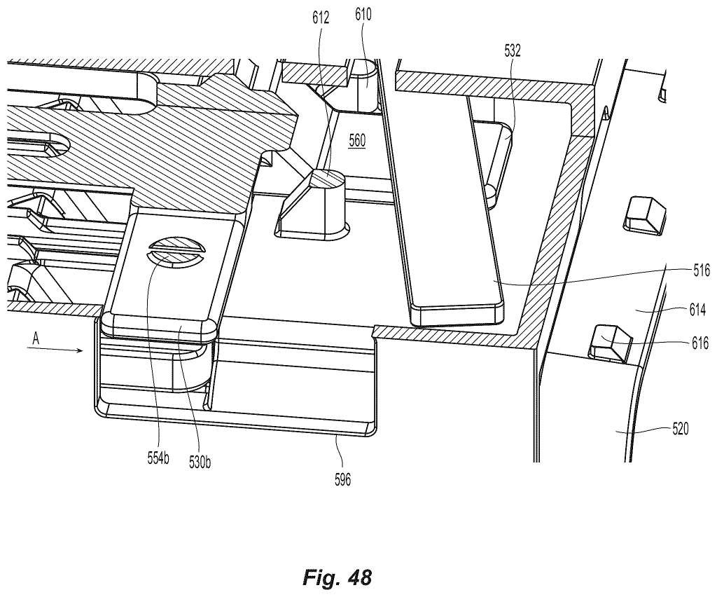

On each of the sides of the slider 576, a wing window 596 is provided. The wing window 596 is configured to engage with the respective wing 530a/530b of the latch 510 when the slider 576 is pulled backward. See rearward pointing arrow A in FIG. 48. This engagement occurs when the 4-port ganged fiber optic connector 500 is pulled rearward for removal from the adapter 106. The engagement of the wing window 596 with the wing 530a/530b provides force required to pull the detents 540a/450b at the front of the latch extension 526a/526b downward and out of the four openings 184 in the adapter 106. At the same time, the slider extensions 578 underneath the detents 540a/450b move out to allow the detents 540a/450b to move downward and out of the openings 184, thereby freeing the 4-port ganged fiber optic fiber optic connector 500 from the adapter 106. See FIG. 47. When the slider 576 is moved forward, the wings 530a/530b disengage from the wing window 596 and do not interfere with the movement of the slider 576. Since the slider 576 is designed to be removable from the rest of the 4-port ganged connector 500, the slider 576 cannot have integrally molded lever arms 516 or buttons 554a/554b to contact the latch directly. That is, the lever arms 516 are separate pieces for assembly into the 4-port ganged fiber optic connector 500 (as is the slider 576 too).

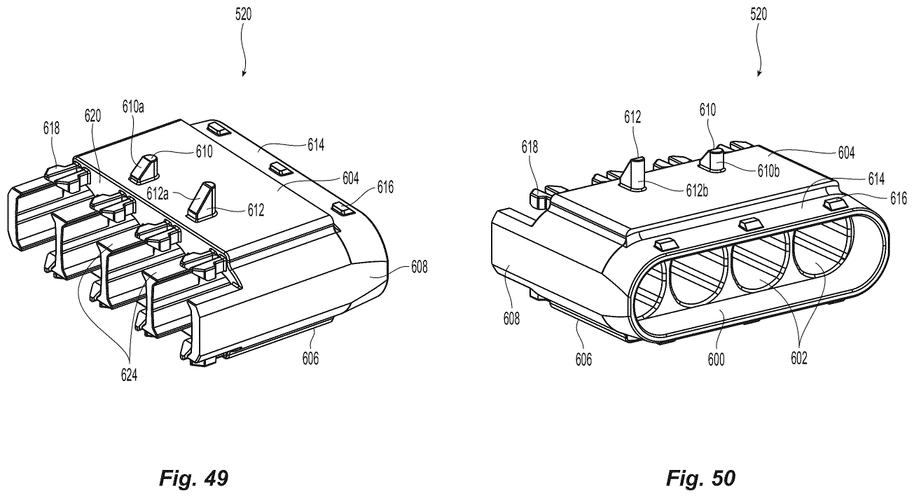

FIGS. 49 and 50 illustrate a front perspective and a rear perspective view, respectively, of the carrier 520. The carrier 520 includes a rear central opening 600 with individual openings 602 for each fiber optic group supported inside respective housing 502 attached forwardly of the carrier 520. The carrier 520 is preferably molded as a single piece structure. Alternatively, the carrier 520 may be molded as a two-piece structure. The carrier 520 has a top surface 604 and a bottom surface 606 joined by opposite side surfaces 608. The top surface 604 has a pair of carrier posts 610/612. Each carrier post 610/612 contacts a respective lever arm 516 between the free end of the lever arm and the engaged end of the lever arm 516. One carrier post 612 is larger (taller) than the other 610 since the lever arms 516 are at different heights relative to the top surface of the carrier 520 due to different positioning of the upper and the lower wings 530a/530b of the latch 510. See again FIG. 33. The bottom side 606 does not have any such carrier posts, and is a flat continuous surface without any features. Each carrier post 610/612 is a wedge shaped structure having a forward facing ramp 610a/612a and a rearward facing vertical surface 610b/612b (curved or flat). When the rearward facing vertical surface 610b/612b of the carrier post is curved, it allows for a continuous and even contact between the carrier post 610/612 and the lever arms 516. Such a shape is to provide strength and stiffness to the respective carrier posts 610/612, and other shapes (flat surfaces) could be used instead. The side surfaces 608 of the carrier 520 are flat to match with the inner surfaces of the adapter 106, thereby easing the movement of the carrier 520, and the overall ganged fiber optic connector 500, relative to the adapter 106.

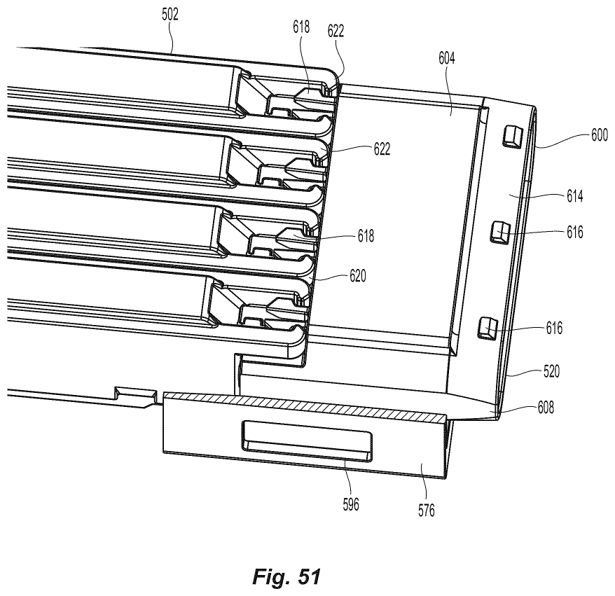

The top and bottom surfaces 604/606 of the carrier 520 include a step 614 where a forward surface of a boot engages (boot not shown). The step 614 prevents any slippage of the boot on the carrier 520 in the forward direction. Towards the rear, each of the top and the bottom surfaces have nubs 616 to fit inside recesses in the boot. The nubs 616 make it easier to secure the boot to the carrier 520. Moving toward the front of the carrier 520, the carrier 520 has a plurality of carrier latches 618 extending forwardly from a carrier latch surface 620 of the carrier 520. As shown in FIG. 51, these carrier latches 618 engage respective housing latches 622 on a rear side of each housing 502. Each carrier latch 618 has rear facing surfaces to engage corresponding forward facing surfaces of the housing latches 622 to transfer forces from the carrier 520 to the housing 502. There may be some float between the carrier latches 618 and the housing latches 622.

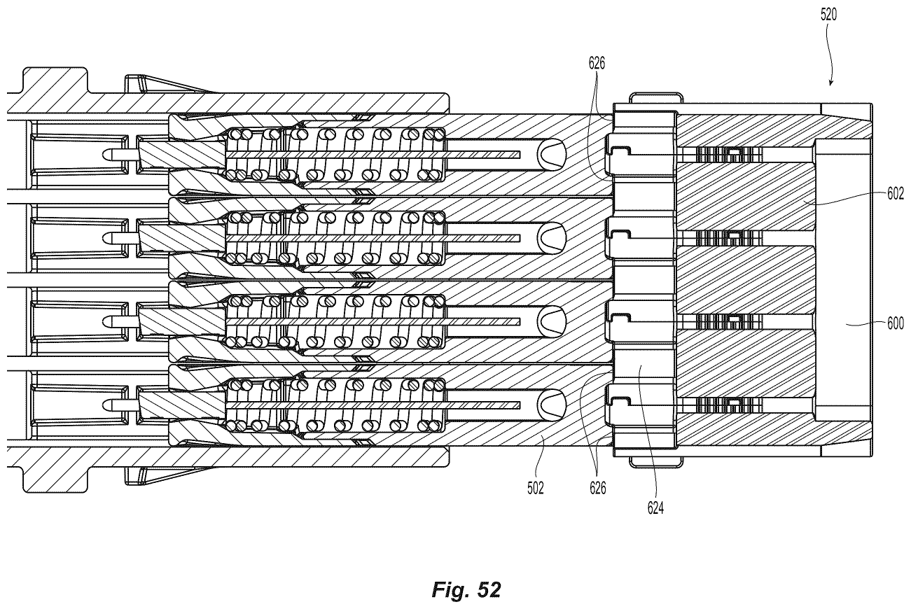

The carrier latches 618 slidably engage ends of the housing latches 622 until the carrier latches 618 snap into a space between a pair of the housing latches 622 on each housing 502. As gleaned from FIG. 51, a similar engagement is provided on the bottom side of the 4-port ganged fiber optic connector 500. Again, it will be noted that the bottom side 606 of the carrier 520 (as shown in FIG. 51) does not show any carrier posts, or other features and is flat. The bottom side 606 of the carrier 520 still has the stepped structure 614 as the top side 604 though, as well as the nubs 616. Once the carrier latches 618 are within the housing latches 622, the ends of each of the housing latches 622 is flush with the carrier latch surface 620. The contact between the housing latches 622 and the carrier latch surface 620 provides a constant forward force to the housings 502 of the 4-port ganged connector, as will be explained with respect to FIG. 52 describing the insertion of the 4-port ganged fiber optic connector 500 into the adapter 106.

Also extending forwardly of the carrier latch surface 620 are a plurality of partitions 624. The partitions 624 separate the individual openings 602. Each partition 624 has a housing engagement surface 626. The housing engagement surface 626 is a forward facing surface that engages a rear facing surface on the housing 502 (see again, e.g., FIG. 52). Between two housings 502 side by side, there is space for a partition 624 to fit in and contact the housings 502. That is, except for the housing engagement surfaces 626 on the outermost sides, each housing engagement surface 626 engages two housings 502 side-by-side. Each housing engagement surface 626 also sees the same force as that on the carrier latch surface 620. Accordingly, since the lever arms 516 multiply the user applied force, each of the housings 502 see a higher push force that pushes the 4-port ganged fiber optic connector 500 into the adapter 106 for mating. As a result, the ganged fiber optic connector 500 can generate up to 40N force on each of the housings 502 even though the user may apply only up to 20N force on the slider 576 to push. The 40N force is sufficient to overcome opposing mating forces F2 from the mating connector(s) or fiber optic ferrules 504a on the other side of the adapter 106 (which side is shown unpopulated in FIG. 32).

A process of insertion and mating of the 4-port ganged fiber optic connector 500 will now be described. It is assumed that the other side of the adapter 106 is populated with housings 502 and mating fiber optic ferrules 504a. When there are opposing fiber optic ferrules 504a present, the rearward forces on the end faces of the fiber optic ferrules 504 of the shown 4-port ganged fiber optic connector 500 get transferred to the latch detents 540a/540b of the latch extensions 526a/526b. When the opposing side of the adapter 106 is not populated, those rearward forces are absent.

FIG. 40 illustrates the position of the connector before the connector assembly is inserted into the adapter 106. The central detent 548 is located in the forward slot 550; a position that provides some resistance to the rearward force exerted on the main body 528 as the latch detents 540a/540b come in contact with the rear facing surface 106a of adapter 106. The slider extensions 578 are in the two respective longitudinal slots 536a/536b of the latch extensions 526a/526b, and are positioned underneath them, which allows room for the latch detents 540a/540b to deflect downward due to the resistance force by the adapter 106. Further forward motion leads to the latch detents 540a/540b to occupy a space inside the adapter openings 184, and the latch posts 538a/538b to come in contact with the adapter 106. So far, there is no structure that resists the downward force on the latch detents 540a/540b inside the openings 184. The latch posts 538a/538b prevent the latch 510 from moving forward any farther forcing the central detent 548 to disengage from the forward slot 550 on the slider 576. At some point during this forward motion, the user may hear an audible click as the central detent 548 moves out of the forward slot 550.

Continuing the forward motion results in the slider extensions 578 to be underneath the latch extensions 526a/526b; a position which prevents any downward movement of the latch detents 540a/540b (see FIG. 46). Simultaneously, the lever arms 516 continue their respective compression as soon as the inner surface 586 of this rear wall 566 of the slider 520 contacts the free ends of the lever arms 516 (see again, FIG. 42). The lever arms 516 rotate about the respective buttons 554a/554b on the latches. At the same time, the lever arms 516 also push against and slide along the respective carrier posts 610/612. The resistance from the carrier posts 610/612 translates to a multiplication of the forces applied by the user. That is, the carrier posts 610/612 act as pivots for each respective lever arm 516. The user force is increased/multiplied in direct proportion to the lengths of the lever arm 516 and the contact point between the lever arm 516 with the carrier posts 610/612 and the contact point between the lever arm 516 inner surface 586 of the rear wall 566 on the slider 576, as long as the contact of the lever arms 516 with the slider 576 is maintained.

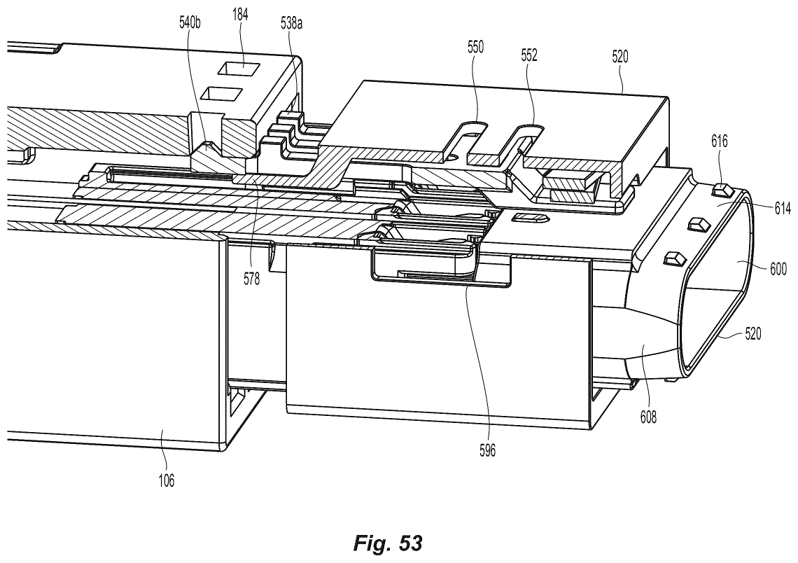

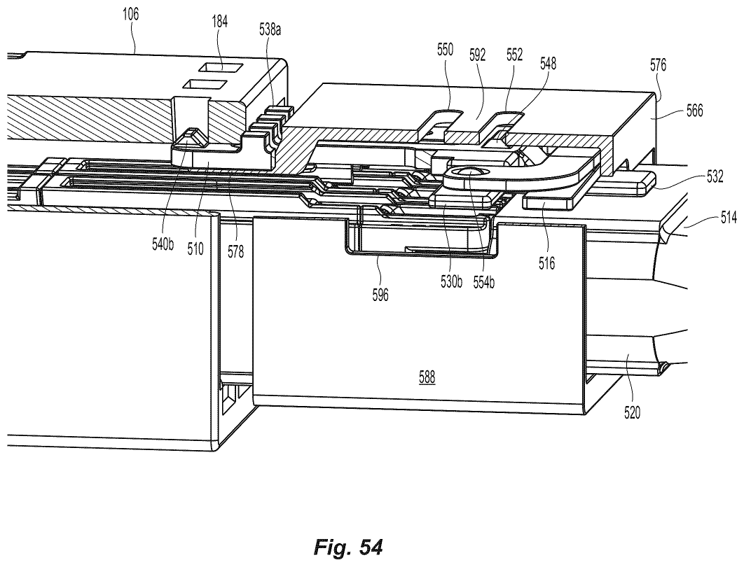

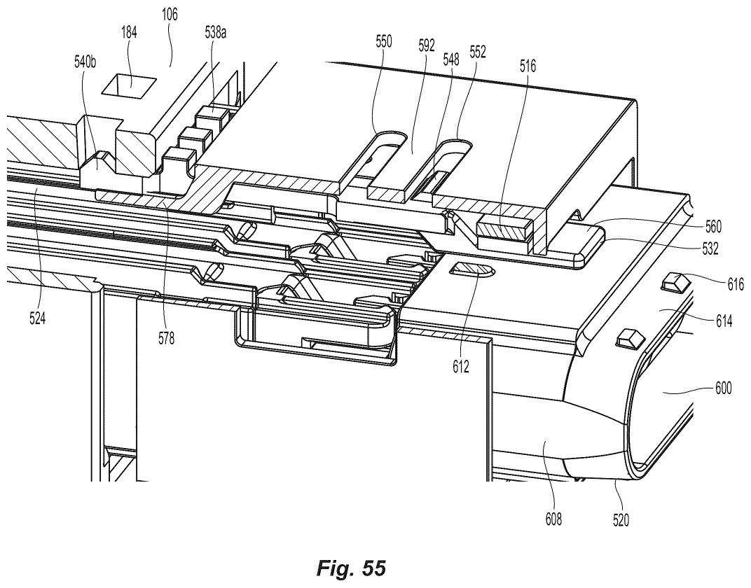

As the slider 576 is continued to be pushed forward, the slider extensions 578 continue moving on top of the respective housings 502 and underneath the detents. See FIGS. 53 and 54, where the slider extension 578 engages the bottom surface of the latch extension 526a/526b. In addition, FIG. 47 shows a relief feature 594 that may aid movement of the central detent 548 as it passes under the bridge 592. Simultaneously, the lever arms 516 further compress against the carrier posts 610/612 and the central detent 548 slides out of the forward slot 550 and moves underneath the bridge 592 between the forward slot 550 and the rearward slot 552. At some point in this continued forward motion, the central detent 548 moves into the rearward slot 552 of the slider 576 past the bridge 592. Again, there may be an audible cue to the user when the central detent 548 moves in the rearward slot 552. See, FIG. 55. At this point, the slider extensions 578 are at their maximum forward positions inside the adapter 106. The central detent 548 has a rear facing ramp or wall that resists any further motion of the slider 576 and provides a feedback to the user (in addition to the audible click) to stop pushing further. However, if the user were to continue to push farther, the slider 576 may move forward a bit more to hit the posts 538a/538b in the latch extension 526a/526b to the rear facing surface 106a that would then stop the forward motion of the slider 576. Since the slider extensions 578 engage a bottom surface of the latch 510 underneath the detents 540a/540b, it will be impossible for the detents 540a/540b to pop out of the openings 184 in the adapter in a reasonable use of the setup.

The lever arms 516 are under maximum compression at this point, meaning the inner surface 586 of the rear wall 566 on the slider 576 is the furthest forward it can be during normal use, and the connector housings 502 are under forces that can mate with the opposing connector housings and fiber optic ferrules 504a. The central detent 548 also has a forward facing ramp or wall that resists the slider 576 from being pushed rearward by the lever arms 516 trying to de-compress. Thus, even under maximum compression, the lever arms 516 cannot push the slider rearward due to the central detent 548 preventing such a motion. Such maximum compression of the lever arms 516 is also experienced by the carrier posts 610/612 which transmit the force onto the housing engagement surfaces 626 and the carrier latch surface 620 (see again FIG. 51). Due to contact with the housing latches 622, these two surfaces of the carrier-housing engagement surfaces and the carrier latch surface-provide a uniform forward force to the housings 502, and thus to the fiber optic ferrules 504 therein, to mate with opposing fiber optic ferrules 504a on the other side of the adapter 106. As known to one of ordinary skill in the art, each of the housings 502 have an internal spring that gets compressed and provides the mating force at the end faces of the fiber optic ferrules 504, as the carrier 520 pushes these housings 502 forward. See again, the cross-section of FIG. 52 showing the springs, the spring push surface of each housing, and a portion of the optical fiber ribbon, in addition to the aforementioned features.

To remove the 4-port ganged connector from the adapter 106, the user can pull the slider 576 rearward. The user force is sufficient to overcome the opposition from the central detent 548, which now moves out of the rearward slot 552 towards the forward slot 550, generally following the opposite motion of the motion described above. As the rearward motion continues, the wing window 596 of the slider engages the wing 530 on each side of the slider. See, e.g., FIG. 48. At the same time, the slider extensions 578 disengage from the bottom side of the latch extension 526a/526b and move out from underneath the detents 540. The engagement of the wing 530 with the slider 576 translates to a downward force on the detents 540 from the walls of the openings 184 in the adapter 106. Since the slider extensions 578 are no longer present to block the detents 540 in their downward motion, the detents 540 move out of the openings 184, and the whole 4-port ganged fiber optic connector 500 is detached from the adapter 106.

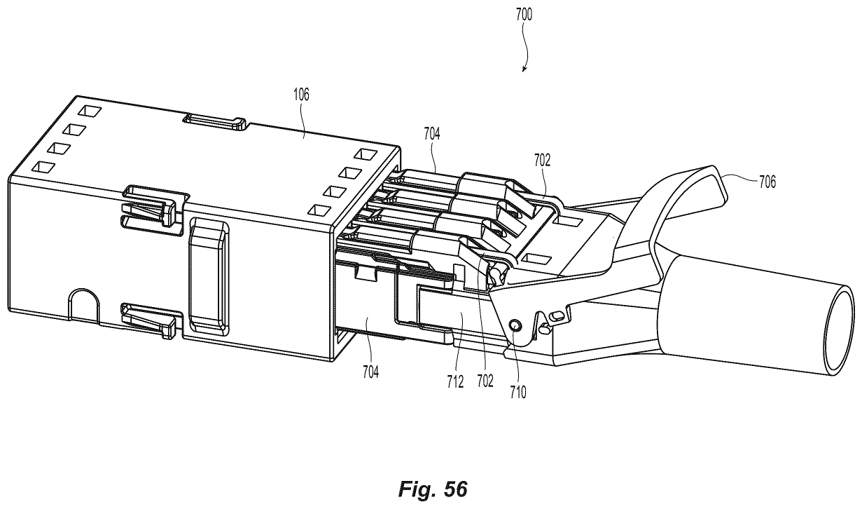

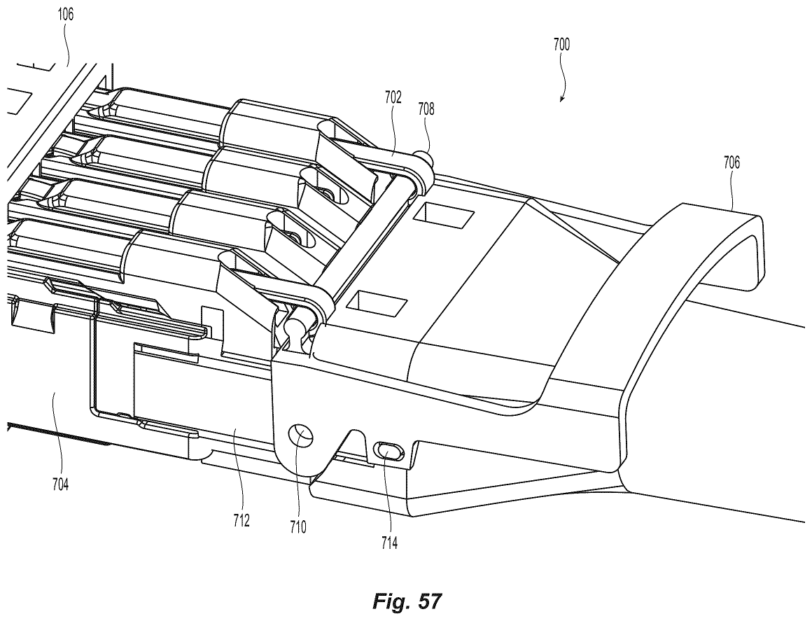

Another embodiment of a fiber optic connector 700 according to the present invention is illustrated in FIGS. 56-57. In this embodiment a pair of latches 702 with connection hooks engages with the opening in the adapter 106 first. These two latches 702 are respectively located on the outer most housings 704, but could instead be located on the inner two housings of the 4-port ganged fiber optic connector 700 as an alternative. Once these latches 702 engage with the adapter 106, a lever arm 706 is pulled down, which provides the necessary mechanical advantage that the operator sees when the fiber optic ferrules 504, 504a are mated. The lever arm 706 has a beam 708 that goes through the respective connection hooks of the two latches 702. That is, the hooks 702 may go about the beam 708 from the top (as shown), or from the bottom side of the beam 708. As the lever arm 706 is being lowered, it pivots about a pivot point 710 on the carrier 712 forcing the housings 704 and the ferrules to move forward until the middle latches engage. With all the four latches 702 engaged with the adapter 106, the lever arm 706 rests in a horizontal position secured via a nub 714 on the boot, as also shown in FIG. 57. To remove the ganged fiber optic connector 700, the lever arm 706 may be lifted in a direction away from the position shown in FIG. 57, and a reverse operation occurs to de-latch the housings 704 and the engagement mechanism 510 (i.e., including the latches 702 in this variation) from the adapter 106.

Applicant notes that the term “front” or “forward” means that direction where the fiber optic connectors 100-500 and 700 would meet with another fiber optic connector or device or mating ferrules 104a, 504a, while the term “rear” or “rearward” is used to mean the direction from which the optical fibers enter into the fiber-optic ferrules or fiber optic connectors 100-500 and 700. Each of the components will therefore have a front and rear, and the two respective fronts or forward portions of opposing ferrules 104, 104a and 504,504a, for example, would engage one another. Thus, for example, in FIG. 3, the “front” of the fiber optic connector 100 is on the left side and “forward” is to the left of the page. “Rearward” or “rear” is that part of the fiber optic connector 100 that is on the right side of the page and “rearward” and “backward” is toward the right of the page.

It will be apparent to those skilled in the art that various modifications and variations can be made to the present invention without departing from the spirit and scope of the invention. Thus it is intended that the present invention cover the modifications and variations of this invention provided they come within the scope of the appended claims and their equivalents.

We claim:

1. A fiber optic connector, comprising:
a fiber optic ferrule supporting at least one optical fiber terminated at a front end of the fiber optic ferrule;
a housing partially surrounding the fiber optic ferrule;
a carrier engaged to the housing rearward thereof;
a connector boot coupled to the carrier at a rear portion of the carrier; and
a converter coupled to the connector boot at a front portion of the connector boot and having an engagement mechanism to engage with an adapter within which the fiber optic connector mates with at least one another fiber optic ferrule on an opposite side of the adapter in a longitudinal direction,
wherein the connector boot is movable rotationally between a plurality of positions with a torque about a longitudinal axis, the torque generating a longitudinal force on the converter and on the carrier, the longitudinal force being transferred to the fiber optic ferrule as a mating force for mating with the at least one another fiber optic ferrule.

2. The fiber optic connector according to claim 1, wherein the carrier includes a crimp body.

3. The fiber optic connector according to claim 1, wherein the carrier biases the engagement mechanism against a portion of the adapter after the longitudinal force has been applied.

4. The fiber optic connector according to claim 1, wherein the connector boot has a projection and the converter has a groove to receive the projection on the connector boot.

5. The fiber optic connector according to claim 4, wherein the projection extends around at least a portion of a circumference of the connector boot.

6. The fiber optic connector according to claim 1, wherein the fiber optic connector is inserted into the adapter before the another fiber optic connector.

7. The fiber optic connector according to claim 1, wherein the carrier includes a rearward facing surface to engage at least one forward facing surface of the converter.

8. The fiber optic connector according to claim 4, wherein the groove in the connector boot has a locking portion to prevent unintended movement of the carrier and converter.

9. The fiber optic connector according to claim 1, wherein the fiber optic connector includes at least three fiber optic ferrules, each of the at least three fiber optic ferrules supporting at least one optical fiber terminated at a front end of each of the at least three fiber optic ferrules and a housing partially surrounding each of the at least three fiber optic ferrules.

10. A fiber optic connector, comprising:
a fiber optic ferrule supporting at least one optical fiber terminated at a front end of the fiber optic ferrule;
a housing partially surrounding the fiber optic ferrule;
a turning element located rearward of the housing; and
a converter coupled to the turning element at a front portion of the turning element and having an engagement mechanism to engage with an adapter,
wherein the turning element is movable rotationally about a longitudinal axis between a plurality of positions to exert a longitudinal force to the fiber optic ferrule.

11. The fiber optic connector according to claim 10, wherein the longitudinal axis about which the turning element is moved is orthogonal to a longitudinal axis to the fiber optic connector.

12. The fiber optic connector according to claim 10, further comprising a carrier engaged at the front of the turning element.

13. The fiber optic connector according to claim 10, wherein the turning element has a groove and the converter has a projection to engage the groove in the turning element.

14. The fiber optic connector according to claim 13, wherein the projection extends around at least a portion of a circumference of the turning element.

15. A fiber optic connector comprising:
a fiber optic ferrule supporting at least one optical fiber terminated at a front end of the fiber optic ferrule;
a housing partially surrounding the fiber optic ferrule;
a turning element located rearward of the housing; and
a converter coupled to the turning element at a front portion of the turning element and having an engagement mechanism to engage with an adapter,
wherein the turning element is movable rotationally orthogonally to a longitudinal axis along the fiber optic connector between a plurality of positions to exert a longitudinal force to the fiber optic ferrule, whereby the fiber optic ferrule moves between a first longitudinal position to a second longitudinal position in response to the longitudinal force.

16. The fiber optic connector according to claim 15, wherein the turning element is at least one lever engaged at a rear portion of the fiber optic connector.

17. The fiber optic connector according to claim 15, wherein the turning element is a lever arm that is rotationally coupled to an engagement mechanism on the housing of the fiber optic connector.

18. The fiber optic connector according to claim 17, wherein the engagement mechanism is on a carrier of the housing.

19. The fiber optic connector according to claim 15, further comprising a carrier attached to the housing and located rearward of the housing, wherein the engagement mechanism is in contact with the carrier to exert the longitudinal force.

20. The fiber optic connector according to claim 15, wherein the engagement mechanism is latched at an adapter opening or window prior to the fiber optic ferrule mating.
